(19) United States
(12) Patent Application Publication
(10) Pub. No.: US 2025/0350052 A1
(43) Pub. Date: Nov. 13, 2025

(54) HYBRID CONNECTOR

(71) Applicant: HOSIDEN CORPORATION, Osaka (JP)

(72) Inventors: Kyohei MATSUMOTO, Yao-shi (JP); Masakazu YAMAZAKI, Yao-shi (JP)

(73) Assignee: HOSIDEN CORPORATION, Osaka (JP)

(21) Appl. No.: 19/065,204

(22) Filed: Feb. 27, 2025

(30) Foreign Application Priority Data
May 13, 2024 (JP) 2024-077824

(51) Int. Cl. H01R 12/71; H01R 12/57; H01R 12/58; H01R 12/70; H01R 13/11; H01R 13/422; H01R 13/50

(52) U.S. Cl. CPC H01R 12/716; H01R 12/57; H01R 12/58; H01R 13/111; H01R 13/113; H01R 13/422; H01R 13/50; H01R 12/707

(57) ABSTRACT

A hybrid connector including first and second connector part and a coupling part. The first connector part includes a first body extending in a first direction, at least one first terminal, and a shell. The shell includes a shell body covering an outer face of the first body, at least partly, and at least one third mountable portion. The second connector part includes a second body extending in the first direction and being disposed in spaced relation to the first body in a second direction. The coupling part couples the first body and the second body and includes at least one through hole extending through the coupling part in the first direction. The at least one third mountable portion of the shell is at least partly disposed on the other side in the first direction relative to, or at least partly disposed in, the at least one through hole.

### CROSS-REFERENCE TO RELATED APPLICATION

The present application claims priority under 35 U.S.C. § 119 of Japanese Patent Application No. 2024-077824 filed on May 13, 2024, the disclosure of which is expressly incorporated by reference herein in its entirety.

### BACKGROUND OF THE INVENTION

### Technical Field

The invention relates to hybrid connectors.

### Background Art

JP 2017-520132 A (see FIGS. 13 to 15) describes conventional first and second connectors. The first connector is a coaxial connector. The second connector includes an insulating body, a plurality of terminals retained by the body, and a pair of fixing members.

The first connector is mounted on a circuit board. The second connector is also mounted on the same circuit board. Specifically, the body of the second connector is fixed to the circuit board, the plurality of terminals of the second connector are in contact with a plurality of electrodes of the circuit board, and the pair of fixing members of the second connector is fixed by soldering. The second connector is thus mounted in position relative to the first connector on the circuit board.

### SUMMARY OF INVENTION

The first and second connectors are provided separately. Therefore, each time the first and second connectors are mounted on the circuit board, absolute positions of the first and second connectors on the circuit board and relative positions between the first and second connectors (a distance therebetween and/or their orientations) vary.

The invention provides a hybrid connector including two connector parts with reduced variations in their absolute and relative positions.

A hybrid connector according to an aspect of the invention includes a first connector part, a second connector part, and a coupling part.

The first connector part includes a first body and at least one first terminal. The first body is constituted by an insulating material and extends in a first direction. The at least one first terminal is constituted by an electrically conductive material, and the at least one first terminal includes a first retainable portion, a first contacting portion, and a first mountable portion. The first retainable portion is retained in the first body. The first contacting portion extends from the first retainable portion to one side in the first direction. The first contacting portion is exposed, or protrudes, at least partly from the first body. The first direction is a height direction of the first body. A second direction is substantially orthogonal to the first direction. A third direction is substantially orthogonal to the first direction and crosses the second direction.

The second connector part includes a second body constituted by an insulating material, and at least one second terminal constituted by an electrically conductive material. The second body extends in the first direction, and is disposed in spaced relation to, and on the other side in the second direction relative to, the first body. The at least one second terminal includes a second retainable portion, a second contacting portion, and a second mountable portion. The second retainable portion is retained in the second body. The second contacting portion extends from the second retainable portion to the one side in the first direction. The second contacting portion is exposed, or protrudes, at least partly from the second body.

The coupling part couples the first body and the second body and includes at least one through hole extending through the coupling part in the first direction.

The first connector part may further include a shell having electrical conductivity. The shell may include a shell body covering at least a part of an outer face of the first body. and at least one third mountable portion.

The shell may further include at least one third mountable portion. The at least one third mountable portion of the shell may be at least partly disposed on the other side in the first direction relative to, or at least partly disposed in, the at least one through hole. In this case, the first mountable portion of the at least one first terminal may be at least partly located on the other side in the first direction, one side in a second direction, one side in a third direction, or the other side in the third direction relative to the first body, and the second mountable portion of the at least one second terminal may be at least partly located on the other side in the first direction, the other side in the second direction, the one side in the third direction, or the other side in the third direction relative to the second body.

Alternatively, a part of the first mountable portion of the at least one first terminal may be disposed on the other side in the first direction relative to, or disposed in, the at least one through hole. In this case, the second mountable portion of the at least one second terminal may be at least partly located on the other side in the first direction, the other side in the second direction, the one side in the third direction, or the other side in the third direction relative to the second body. The shell may or may not be provided.

Still alternatively, a part of the second mountable portion of the at least one second terminal may be disposed on the other side in the first direction relative to, or disposed in, the at least one through hole. In this case, the first mountable portion of the at least one first terminal may be at least partly located on the other side in the first direction, the one side in the second direction, the one side in the third direction, or the other side in the third direction relative to the first body. The shell may or may not be provided.

The hybrid connector of any of the aspects described above is structured such that the coupling part couples the first body of the first connector part and the second body of the second connector part. In each mount of the hybrid connector on a circuit board, this structure reduces variations in respective absolute positions of the first connector part and the second connector part on the circuit board, and also reduces variations in relative positional relationship of the first connector part and the second connector part on the circuit board.

### BRIEF DESCRIPTION OF DRAWINGS

FIG. 1A is a front, top, right side perspective view of a hybrid connector according to a first embodiment of the invention.

FIG. 1B is a rear, bottom, left side perspective view of the hybrid connector of the first embodiment.

FIG. 1C is a front view of the hybrid connector according to the first embodiment.

FIG. 1D is a rear view of the hybrid connector of the first embodiment.

FIG. 1E is a plan view of the hybrid connector of the first embodiment.

FIG. 1F is a bottom view of the hybrid connector of the first embodiment.

FIG. 2A is a cross-sectional view of the hybrid connector of the first embodiment, taken along line 2A-2A in FIG. 1E.

FIG. 2B is a partial cross-sectional view of the hybrid connector of the first embodiment, taken along line 2B-2B in FIG. 1E.

FIG. 2C is a cross-sectional view of the hybrid connector of the first embodiment, taken along line 2C-2C in FIG. 1E.

FIG. 2D is a cross-sectional view of the hybrid connector of the first embodiment, taken along line 2D-2D in FIG. 1E.

FIG. 2E is a cross-sectional view of the hybrid connector of the first embodiment, taken along line 2E-2E in FIG. 1C.

FIG. 2F is a cross-sectional view of the hybrid connector of the first embodiment, taken along line 2F-2F in FIG. 1C.

FIG. 3A is a front, top, right side perspective, exploded view of the hybrid connector according to the first embodiment.

FIG. 3B is a rear, bottom, left side perspective, exploded view of the hybrid connector of the first embodiment.

FIG. 4 is a rear, bottom, left side perspective view of a hybrid connector according to a second embodiment of the invention.

FIG. 5 is a cross-sectional view of the hybrid connector of the second embodiment, taken along line 5-5 in FIG. 4.

FIG. 6 is a rear, bottom, left side perspective view of a hybrid connector according to a third embodiment of the invention.

FIG. 7 is a cross-sectional view of the hybrid connector of the third embodiment, taken along line 7-7 in FIG. 6.

FIG. 8A is a cross-sectional view, corresponding to FIG. 2A, of a variant of the hybrid connector of the first embodiment.

FIG. 8B is a partial cross-sectional view, which corresponds to FIG. 2B, of the variant of the hybrid connector of the first embodiment.

FIG. 9A is a cross-sectional view, which corresponds to FIG. 5, of a variant of the hybrid connector of the second embodiment.

FIG. 9B is a partial cross-sectional view, which corresponds to FIG. 2B, of the variant of the hybrid connector of the second embodiment.

FIG. 10A is a cross-sectional view, corresponding to FIG. 7, of a variant of the hybrid connector of the third embodiment.

FIG. 10B is a partial cross-sectional view, which corresponds to FIG. 2B, of the variant of the hybrid connector of the third embodiment.

In the brief description of the drawings above and the description of embodiments which follows, relative spatial terms such as “upper”, “lower”, “top”, “bottom”, “left”, “right”, “front”, “rear”, etc., are used for the convenience of the skilled reader and refer to the orientations of the hybrid connectors and their constituent parts as depicted in the drawings. No limitation is intended by use of these terms, either in use of the invention, during its manufacture, shipment, custody, or sale, or during assembly of its constituent parts or when incorporated into or combined with other apparatus.

### DESCRIPTION OF EMBODIMENTS

A plurality of embodiments of the invention, including first to third embodiments and variants thereof, will now be described. It should be noted that constituents of the embodiments and their variants to be described can be combined in any possible manner. It should also be noted that the materials, the shapes, the dimensions, the numbers, the arrangements, etc. of the constituents of the embodiments and their variants to be described are presented by way of example only and can be modified in any manner as long as the same functions can be fulfilled.

### First Embodiment

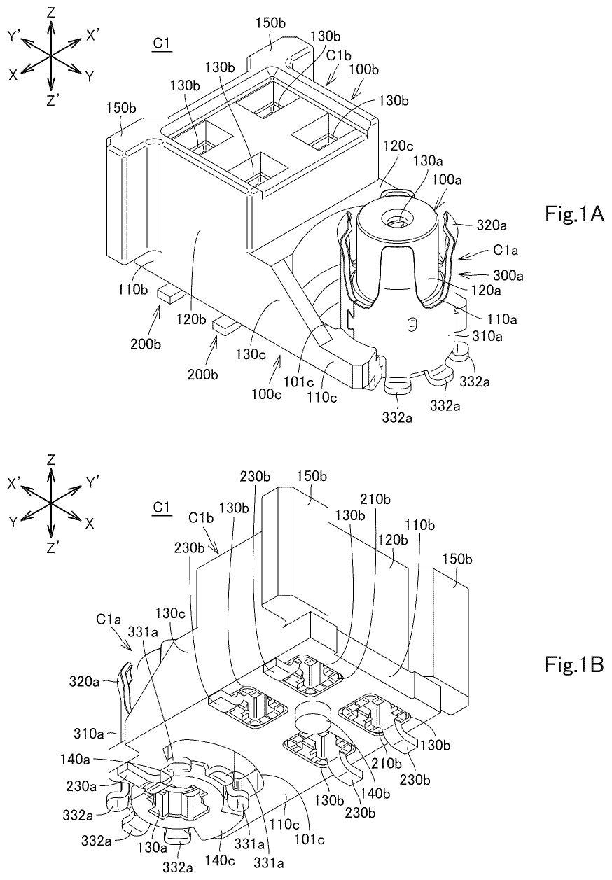

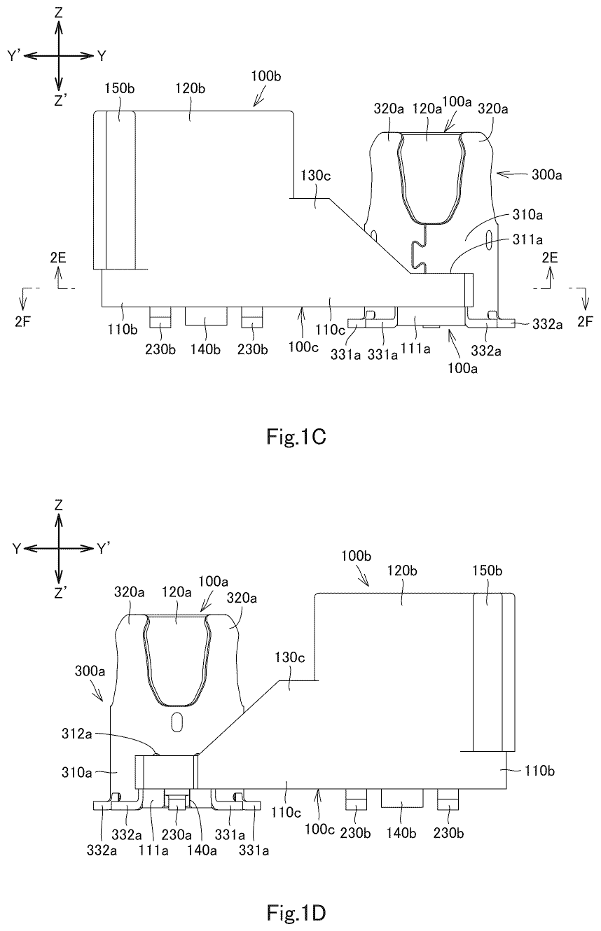

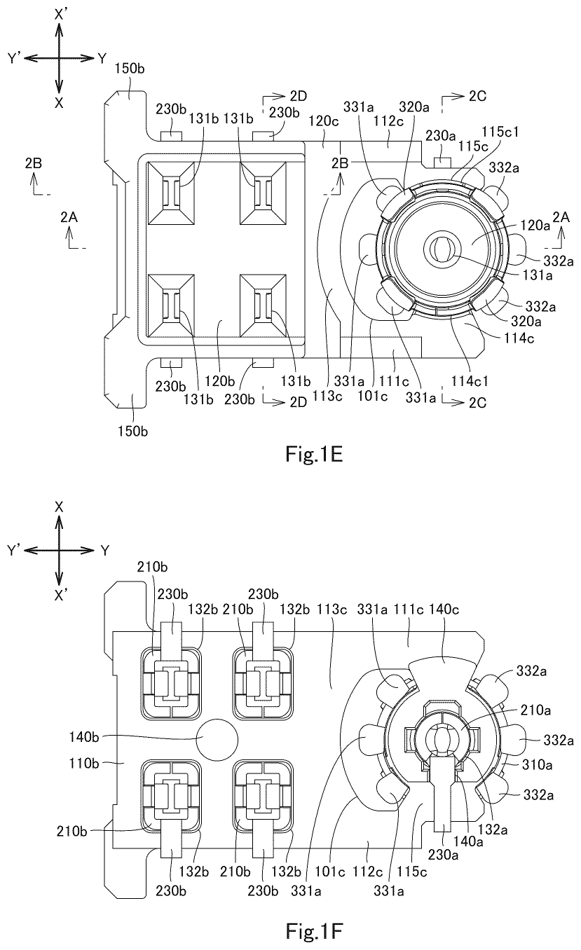

A hybrid connector C1 (which may be referred to simply as “the connector C1”) according to a plurality of embodiments including the first embodiment of the invention and variants thereof will now be described with reference to FIGS. 1A to 3B. FIGS. 1A to 3B illustrate the connector C1 of the first embodiment. FIGS. 1A to 1D, 2A to 2D, 3A, and 3B show a Z-Z′ direction (first direction). The Z-Z′ direction includes a Z direction (one side in the first direction) and a Z′ direction (the other side in the first direction). FIGS. 1A to 2B and 2C to 3B show a Y-Y′ direction (second direction). The Y-Y′ direction is substantially orthogonal to the Z-Z′ direction, and includes a Y direction (one side in the second direction) and a Y′ direction (the other side in the second direction). FIGS. 1A, 1B, 1E, 1F, 2C to 3A, and 3B show an X-X′ direction. The X-X′ direction is substantially orthogonal to the Z-Z′ and Y-Y′ directions. The X-X′ direction includes an X direction and an X′ direction. As used herein the term “first oblique direction” refers to an oblique direction including components of the Y′ and X directions, the term “second oblique direction” refers to an oblique direction including components of the Y′ and X′ directions, the term “third oblique direction” refers to an oblique direction including components of the Y and X directions, and the term “fourth oblique direction” refers to an oblique direction including components of the Y and X′ directions. The fourth oblique direction is opposite to the first oblique direction. The third oblique direction is opposite to the second oblique direction. As used herein a “third direction” corresponds to the X-X′ direction, oblique directions including the first and fourth oblique directions, and oblique directions including the second and third oblique directions. “One side in the third direction” corresponds to the X direction, the first oblique direction, and the third oblique direction. “The other side in the third direction” corresponds to the X′ direction, the second oblique direction, and the fourth oblique direction. It should be noted the third direction may be any direction that is substantially orthogonal to the Z-Z′ direction and crosses the Y-Y′ direction.

The connector C1 includes a first connector part C1a, a second connector part C1b, and a coupling part 100c, each of which will be described in detail.

The first connector part C1a includes a first body 100a. The first body 100a is constituted by an insulating material (e.g., an insulating resin or the like material) and extends in the Z-Z′ direction. The Z-Z′ direction is a height direction of the first body 100a.

For example, the first body 100a may be a generally circular-section column extending in the Z-Z′ direction (see FIGS. 1A to 1E, 2A, 2C, and 2E to 3B) or a generally polygonal-section column extending in the Z-Z′ direction (not illustrated). The central axis of the first body 100a extends in the Z-Z′ direction. The first body 100a includes a base 110a, a distal portion 120a, and at least one first housing hole 130a.

The base 110a includes a lower portion 111a on the Z′-direction side and an upper portion 112a on the Z-direction side relative to the lower portion 111a. The upper portion 112a may be a generally circular-section column extending in the Z-Z′ direction (see FIGS. 1A to 1E, 2A, 2C, and 2E to 3B) or a generally polygonal-section column extending in the Z-Z′ direction (not illustrated). The lower portion 111a may be a generally circular-section column extending in the Z′ direction from the upper portion 112a (see FIGS. 1A to 1E, 2A, 2C, and 2E to 3B) or a generally polygonal-section column extending in the Z′ direction from the upper portion 112a (not illustrated). The lower portion 111a of the base 110a have an outer shape in a cross section along the X-X′ and Y-Y′ directions that may be different from (see FIGS. 1A to 1E, 2A, 2C, 3A, and 3B), or alternatively substantially identical to (not illustrated), an outer shape of the upper portion 112a of the base 110a in a cross section along the X-X′ and Y-Y′ directions. The lower portion 111a of the base 110a has outer dimensions in the cross section along the X-X′ and Y-Y′ directions that may be smaller than (see FIGS. 1A to 1E, 2A, 2C, 3A, and 3B), or alternatively substantially equal to (not illustrated), outer dimensions of the upper portion 112a of the base 110a in the cross section along the X-X′ and Y-Y′ directions.

The distal portion 120a may be a generally circular-section column extending from the base 110a in the Z direction (see FIGS. 1A to 1E, 2A, 2C, and 2E to 3B) or a generally polygonal-section column extending from the base 110a in the Z direction (not illustrated). The distal portion 120a has an outer shape in a cross section along the X-X′ and Y-Y′ directions that may preferably be substantially identical to (see FIGS. 1A to 1E, 2A, 2C, 3A, and 3B), but may be different from (not illustrated), the outer shape of the upper portion 112a of the base 110a in the cross section along the X-X′ and Y-Y′ directions. The distal portion 120a has outer dimensions in the cross section along the X-X′ and Y-Y′ directions that may be smaller than (see FIGS. 1A to 1E, 2A, 2C, 3A, and 3B), or substantially equal to (not illustrated), the outer dimensions of the upper portion 112a of the base 110a in the cross section along the X-X′ and Y-Y′ directions.

The at least one first housing hole 130a may be a single first housing hole or a plurality of first housing holes. For convenience of description, the at least one first housing hole 130a will be described as a single first housing hole 130a. However, also where a plurality of first housing holes 130a is provided, each of the first housing holes 130a may be configured similarly to the first housing hole 130a described below.

The first housing hole 130a extends through the first body 100a in the Z-Z′ direction. The first housing hole 130a includes a first opening 131a on the Z-direction side and a second opening 132a on the Z′-direction side. The first opening 131a has a shape in a cross section along the X-X′ and Y-Y′ directions that may be different from (see FIGS. 1A, 1B, 1E, 1F, 2A, 2C, 3A and 3B), or alternatively substantially identical to (not illustrated), a shape of the second opening 132a in a cross section along the X-X′ and Y-Y′ directions. The first opening 131a has dimensions in the cross section along the X-X′ and Y-Y′ directions that may be smaller than (see FIGS. 1A, 1B, 1E, 1F, 2A, 2C, 3A and 3B), or alternatively substantially equal to (not illustrated), dimensions of the second opening 132a in the cross section along the X-X′ and Y-Y′ directions.

The first body 100a may further include at least one first notch 140a. The at least one first notch 140a is a single first notch 140a or a plurality of first notches 140a, corresponding to the number of the at least one first housing hole 130a. For convenience of description, the at least one first notch 140a will also be described as a single first notch 140a. However, also where a plurality of first notches 140a is provided, each of the first notches 140a may be configured similarly to the first notch 140a described below.

The first notch 140a extends through the lower portion 111a of the base 110a in the Y direction (not illustrated), the X direction (not illustrated), the X′ direction (see FIGS. 1B, 1D, 1F, 2C, and 3B), the first oblique direction (not illustrated), the second oblique direction (not illustrated), the third oblique direction (not illustrated), or the fourth oblique direction (not illustrated). The first notch 140a communicates with the first housing hole 130a. The first notch 140a opens in the Z′ direction.

The first body 100a of any aspect described above includes a face on the Z′-direction side. The face on the Z′-direction side of the first body 100a is also the face on the Z′-direction side of the lower portion 111a of the base 110a.

The second connector part C1b includes a second body 100b. The second body 100b is constituted by an insulating material (e.g., an insulating resin or the like material) and extends in the Z-Z′ direction. The second body 100b is disposed on the Y′-direction side relative to the first body 100a.

For example, the second body 100b may be a generally polygonal-section column extending in the Z-Z′ direction (see FIGS. 1A to 1E, 2B, and 2D to 3B) or a generally circular-section column extending in the Z-Z′ direction (not illustrated). The second body 100b may be a generally quadrangular-section column as shown in FIGS. 1A to 1E, 2B, and 2D to 3B, but may be any generally polygonal-section column other than the generally quadrangular-section column. The second body 100b includes a lower portion 110b on the Z′-direction side and an upper portion 120b on the Z-direction side relative to the lower portion 110b.

The second body 100b includes at least one second housing hole 130b. The at least one second housing hole 130b may be a single second housing hole or a plurality of second housing holes. For convenience of description, the at least one second housing hole 130b will be described as a plurality of second housing holes 130b. However, also where a single second housing holes 130a is provided, it may be configured similarly to each of the second housing holes 130b described below.

The plurality of second housing holes 130b (all second housing holes 130b) may, but is not required to, be arranged in a plurality of rows spaced from each other in the Y-Y′ direction, and each row may include a plurality of second housing holes 130b (the number of which is smaller than the number of all second housing holes 130b) spaced from each other in the X-X′ direction. As shown in FIGS. 1A to 1E, 2B, and 2D to 3B, all second housing holes 130b may be arranged in two rows spaced from each other in the Y-Y′ direction, and each row may include two second housing holes 130b spaced from each other in the X-X′ direction. Alternatively, the plurality of second housing holes 130b (all second housing holes 130b) may be arranged in a single row and spaced from each other in the Y-Y′ or X-X′ direction (not illustrated).

Each of the second housing holes 130b extends through the second body 100b in the Z-Z′ direction. Each second housing hole 130b includes a first opening 131b on the Z-direction side and a second opening 132b on the Z′-direction side. The first opening 131b has a shape in a cross section along the X-X′ and Y-Y′ directions that may be substantially identical to (see FIGS. 1A, 1B, 1E, 1F, 2B, and 2D to 3B), or alternatively different from (not illustrated), a shape of the second opening 132b in a cross section along the X-X′ and Y-Y′ directions. The first opening 131b has dimensions in the cross section along the X-X′ and Y-Y′ directions that may be smaller than (see FIGS. 1A, 1B, 1E, 1F, 2B, and 2D to 3B), or alternatively substantially equal to (not illustrated), dimensions of the second opening 132b in the cross section along the X-X′ and Y-Y′ directions.

The second body 100b includes a face on the Z′-direction side. The face on the Z′-direction side of the second body 100b is also the face on the Z′-direction side of the lower portion 110b of the second body 100b.

The face on the Z′-direction side of the second body 100b may be located on the Z-direction side relative to the face of the first body 100a on the Z′-direction side (see FIGS. 1A to 1D, 2A to 2D, and 3B). In this case, the second body 100b may further include at least one protrusion 140b. The at least one protrusion 140b, a single protrusion 140b or a plurality of protrusions 140b, is provided on the face on the Z′-direction side of the second body 100b and protrudes in the Z′ direction. The single protrusion 140b or each of the protrusions 140b has a dimension in the Z-Z′ direction that is substantially equal to a linear distance in the Z-Z′ direction from the face on the Z′-direction side of the second body 100b to the face on the Z′-direction side of the first body 100a. The face on the Z′-direction side of the single protrusion 140b or each of the protrusions 140b is located at substantially the same height position in the Z-Z′ direction as the face on the Z′-direction side of the first body 100a. The at least one protrusion 140b can be omitted.

Alternatively, the face on the Z′-direction side of the second body 100b may be located at substantially the same height position in the Z-Z′ direction as the face on the Z′-direction side of the first body 100a (not illustrated). In this case, the at least one protrusion 140b is omitted, and the second body 100b includes at least one second notch (not illustrated). The at least one second notch may be a single second notch or a plurality of second notches, corresponding to the number of the at least one second housing hole 130b. For convenience of description, the at least one second notch will also be described as a plurality of second notches corresponding to the number of the at least one second housing hole 130b. However, also where a single second notch is provided, it may be configured similarly to each of the second notches described below.

Each of the second notches extends through the lower portion 110b of the second body 100b in the Y′ direction, the X direction, the X′ direction, the first oblique direction, the second oblique direction, the third oblique direction, or the fourth oblique direction. Each of the second notches communicates with the corresponding second housing hole 130b. Each of the second notches opens in the Z′ direction.

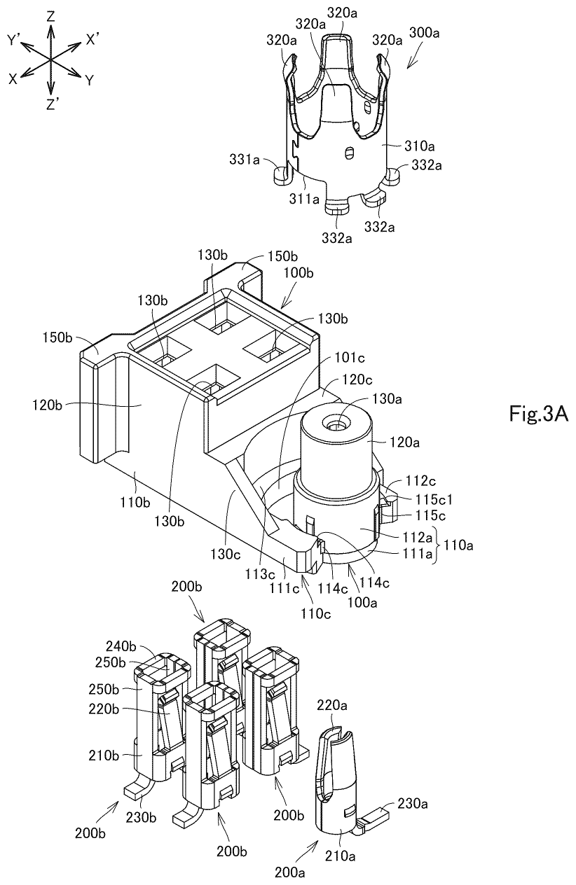

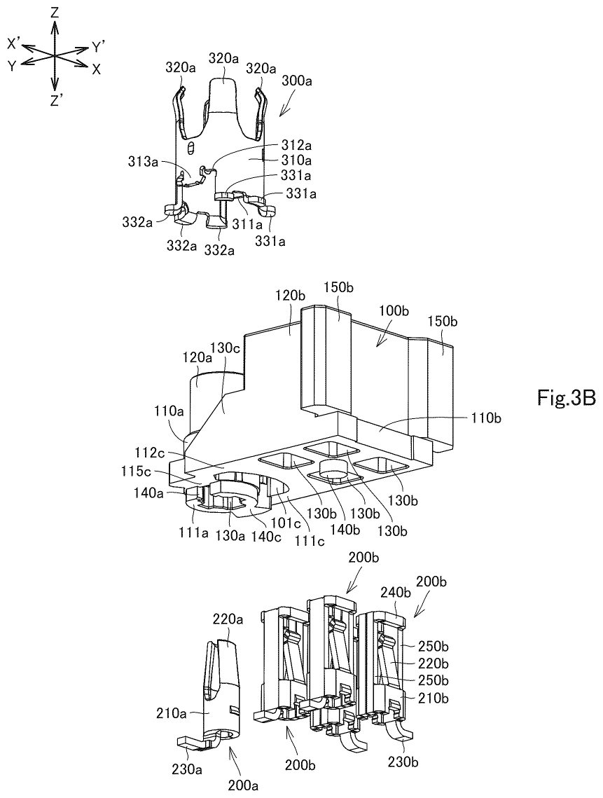

The second body 100b may further include at least one key portion 150b. Where the at least one key portion 150b is a single portion, the key portion 150b extends from the second body 100b to protrude in the Y′ direction, the X direction, the X′ direction, the first oblique direction, or the second oblique direction. Where the at least one key portion 150b is a plurality of portions, each key portion 150b extends from the second body 100b to protrude in the Y′ direction, the X direction, the X′ direction, the first oblique direction, or the second oblique direction. In FIGS. 1A to 1F and 3A to 3B, the at least one key portion 150b may, is not required to be, two key portions 150b, one of which extends from the second body 100b to protrude in the X direction, and the other of which extends from the second body 100b to protrude in the X′ direction. The at least one key portion 150b can be omitted.

The coupling part 100c couples between the first body 100a and the second body 100b. The coupling part 100c may be constituted by an insulating material (e.g., an insulating resin or the like material) and formed integrally with the first body 100a and the second body 100b (see FIGS. 1A to 3B). In this case, the first body 100a, the second body 100b, and the coupling part 100c are integrally molded of an insulating material (e.g., an insulating resin or the like material) to form a single body. Alternatively, the coupling part 100c is provided separately from the first body 100a and the second body 100b, and constituted by an insulating material (e.g., an insulating resin or the like material) or an electrically conductive material (not illustrated). In this case, an end portion on the Y-direction side of the coupling part 100c is fixed to the first body 100a, and an end portion on the Y′-direction side of the coupling part 100c is fixed to the second body 100b. Still alternatively, the coupling part 100c is constituted by an insulating material (e.g., an insulating resin or the like material), formed separately from one of the first body 100a and the second body 100b, and formed with integrally the other body (not illustrated). In this case, one of the end portion on the Y-direction side or the end portion on the Y′-direction side of the coupling part 100c is fixed to the one body, and the other end portion is molded integrally with the other body.

The coupling part 100c includes at least one through hole 101c. The at least one through hole 101c may be a single through hole or a plurality of through holes. For convenience of description, the at least one through hole 101c will be described as a single through hole 101c. However, also where a plurality of through holes 101c is provided, each of the through holes 101c may be configured similarly to the through hole 101c described below. The through hole 101c extends through the coupling part 100c in the Z-Z′ direction.

For example, the coupling part 100c may have one of the following configurations (1) to (6).

(1) The coupling part 100c includes coupling body 110c of a generally ring shape, which is molded integrally with the second body 100b and the first body 100a (see FIGS. 1A to 3B). The coupling body 110c is provided with the through hole 101c extending through the coupling body 110c in the Z-Z′ direction. The coupling body 110c includes a first portion 111c and a second portion 112c. The coupling body 110c may further include a third portion 113c, a fourth portion 114c, and a fifth portion 115c.

The first portion 111c and the second portion 112c extend in the Y-Y′ direction. The first portion 111c is located on the X-direction side relative to the through hole 101c. The second portion 112c is located on the X′-direction side relative to the through hole 101c.

Where the third portion 113c is provided, the third portion 113c is located on the Y′-direction side relative to the through hole 101c, contiguous with end portions on the Y′-direction side of the first portion 111c and the second portion 112c, and contiguous with the lower portion 110b of the second body 100b. Where the third portion 113c is not provided, the first portion 111c and the second portion 112c may be contiguous with the lower portion 110b of the second body 100b.

The fourth portion 114c extends from the end portion on the Y-direction side of the first portion 111c to an end portion on the X-direction side of the upper portion 112a of the base 110a of the first body 100a. The fifth portion 115c extends from the end portion on the Y-direction side of the second portion 112c to an end portion on the X′-direction side of the upper portion 112a of the base 110a of the first body 100a.

In a first boundary portion between the fourth portion 114c and the upper portion 112a of the base 110a of the first body 100a, there may be provided with a first slit 114c1 opening in the Z direction. In a second boundary portion between the fifth portion 115c and the upper portion 112a of the base 110a of the first body 100a, there may be provided with a second slit 115c1 opening in the Z direction.

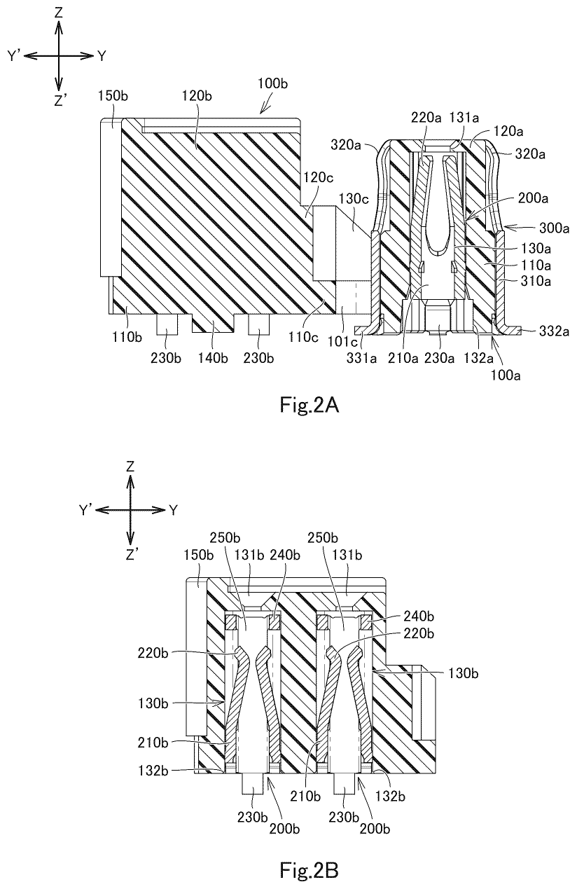

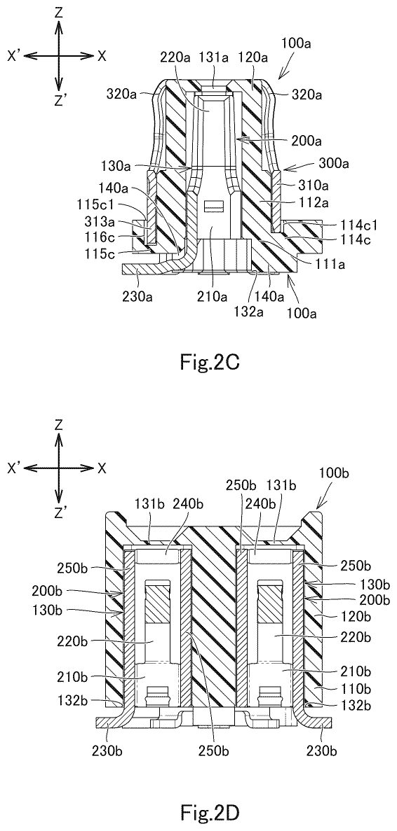

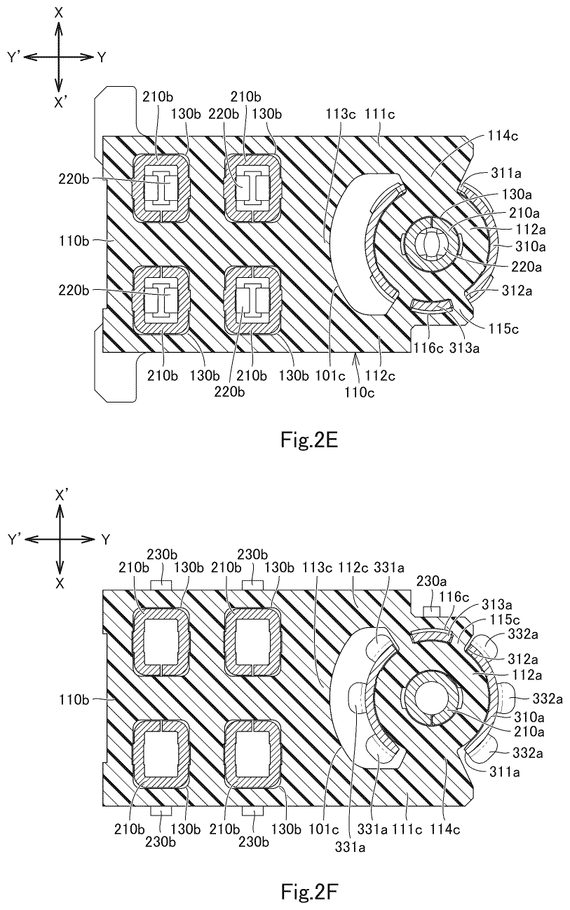

At least one of the first boundary portion and the second boundary portion may be provided with an engaging hole 116c opening in the Z direction. Where the first boundary portion is provided with the first slit 114c1 and the engaging hole 116c, the engaging hole 116c extends in the Z′ direction from the bottom of the first slit 114c1 (not illustrated). Where the first boundary portion is not provided with the first slit 114c1 but is provided with the engaging hole 116c, the engaging hole 116c extends in the Z′ direction from the face on the Z-direction side of the first boundary portion (not illustrated). Where the second boundary portion is provided with the second slit 115c1 and the engaging hole 116c, the engaging hole 116c extends in the Z′ direction from the bottom of the second slit 115c1 (see FIGS. 2C, 2E, and 2F). Where the second boundary portion is not provided with the second slit 115c1 but is provided with the engaging hole 116c, the engaging hole 116c extends in the Z′ direction from the face on the Z-direction side of the second boundary portion (not illustrated). The engaging hole 116c can be omitted.

Where the third portion 113c of the coupling body 110c of the coupling part 100c is provided, the coupling part 100c may further include a projecting portion 120c. The projecting portion 120c is a wall extending in the Z direction from the third portion 113c of the coupling body 110c and being contiguous with the second body 100b. In other words, the projecting portion 120c projects in the Y direction from the second body 100b and is contiguous with the third portion 113c of the coupling body 110c. The projecting portion 120c can be omitted.

The coupling part 100c may further include a pair of reinforcing portions 130c. Where the projecting portion 120c is provided, the pair of reinforcing portions 130c extend in the Y direction from the projecting portion 120c and are contiguous with the first portion 1b1c and the second portion 112c of the coupling body 110c. Where the projecting portion 120c is not provided, the pair of reinforcing portions 130c extend in the Y direction from the second body 100b and are contiguous with the first portion 111c and the second portion 112c of the coupling body 110c. The pair of reinforcing portions 130c reinforce the first portion 111c and the second portion 112c of the coupling body 110c. The reinforcing portions 130c may, but are not required to, each be a wall of generally right-angled triangular shape whose hypotenuse is inclined in an oblique direction including the components of Y and Z′ directions, as shown in FIGS. 1A to 1E, 2A, 3A, and 3B. The pair of reinforcing portions 130c can be omitted.

The coupling body 110c of any aspect described above includes a face on the Z′-direction side. The face on the Z′-direction side of the coupling body 110c is located at a height position as described in (1-1) or (1-2) below.

(1-1) The face on the Z′-direction of the coupling body 110c side may be located on the Z-direction side relative to the face on the Z′-direction side of the first body 100a. (1-1-1) Where the face on the Z′-direction side of the second body 100b is located on the Z′-direction side relative to the face on the Z′-direction side of the first body 100a, the face on the Z′-direction side of the coupling body 110c may be located at substantially the same height position in the Z-Z′ direction as (see FIGS. 1A to 1D, 2A, and 3B), or alternatively at a different height position from (not illustrated), the face on the Z′-direction side of the second body 100b. (1-1-2) Where the face of the second body 100b on the Z′-direction side is located at substantially the same height position as the face on the Z′-direction side of the first body 100a, the face on the Z′-direction side of the coupling body 110c may be located on the Z-direction side relative to the face on the Z′-direction side of the first body 100a and the face on the Z′-direction side of the second body 100b (not illustrated).

The coupling part 100c may further include at least one protrusion 140c. The at least one protrusion 140c, a single protrusion 140c or a plurality of protrusions 140c, is provided on the face on the Z′-direction side of the coupling body 110c and protrudes in the Z′ direction. The single protrusion or each of the protrusions 140c has a dimension in the Z-Z′ direction that is substantially equal to a linear distance in the Z-Z′ direction from the face on the Z′-direction side of the coupling body 110c to the face on the Z′-direction side of the first body 100a. The face on the Z′-direction side of the single protrusion 140c or each of the protrusions 140c is located at substantially the same height position in the Z-Z′ direction as the face on the Z′-direction side of the first body 100a. The at least one protrusion 140c can be omitted.

(1-2) The face on the Z′-direction side of the coupling body 110c may be located at substantially the same height position as the face on the Z′-direction side of the first body 100a and the face on the Z′-direction side of the second body 100b. In this case, the at least one protrusion 140c is omitted.

(2) The coupling part 100c of configuration (2) has the same configuration as the coupling part 100c of configuration (1) described above, except that the coupling body 110c includes neither the fourth portion 114c nor the fifth portion 115c (not illustrated). Where the third portion 113c is provided, the first portion 111c and the second portion 112c extend from the third portion 113c to the upper portion 112a of the base 110a of the first body 100a. Where the third portion 113c is not provided, the first portion 111c and the second portion 112c extend from the lower portion 110b of the second body 100b to the upper portion 112a of the base 110a of the first body 100a. The projecting portion 120c and/or the pair of reinforcing portions 130c may or may not be provided. In a third boundary portion between the first portion 111c and the upper portion 112a of the base 110a of the first body 100a, there may be provided with a third slit opening in the Z direction (not illustrated). In a fourth boundary portion between the second portion 112c and the upper portion 112a of the base 110a of the first body 100a, there may be provided with a fourth slit opening in the Z direction (not illustrated). The engaging hole 116c may or may not extend from the bottom of the third slit and/or the bottom of the fourth slit. Where neither the third slit nor the fourth slit are provided, the engaging hole 116c may or may not be provided on the face on the Z-direction side of the third boundary portion and/or the face on the Z-direction side of the fourth boundary portion.

(3) The coupling body 110c of the coupling part 100c has the same configuration as the coupling body 110c of the coupling part 100c of configuration (1) described above, except that the coupling body 110c of the coupling part 100c is provided separately from the first body 100a and the second body 100b (not illustrated). The fourth portion 114c (an end portion on the Y-direction side) of the coupling body 110c is fixed to the portion on the X-direction side of the upper portion 112a of the base 110a of the first body 100a, and the fifth portion 115c (another end portion on the Y-direction side) of the coupling body 110c is fixed to the portion on the X′-direction side of the upper portion 112a of the base 110a of the first body 100a. Where the third portion 113c (the end portion on the Y′-direction side) of the coupling body 110c is provided, the third portion 113c is fixed to the lower portion 110b of the second body 100b. Where the third portion 113c is not provided, the end portions on the Y′-direction side of the first portion 111c and the second portion 112c of the coupling body 110c are fixed to the lower portion 110b of the second body 100b. The projecting portion 120c and the pair of reinforcing portions 130c are omitted.

(4) The coupling body 110c of the coupling part 100c has the same configuration as the coupling body 110c of the coupling part 100c of configuration (2) described above, except that the coupling body 110c of the coupling part 100c is provided separately from the first body 100a and the second body 100b (not illustrated). The end portion on the Y-direction side of the first portion 111c and the end portion on the Y-direction side of the second portion 112c of the coupling body 110c are fixed to the upper portion 112a of the base 110a of the first body 100a. Where the third portion 113c of the coupling body 110c is provided, the third portion 113c (the end portion on the Y′-direction side) of the coupling body 110c is fixed to the lower portion 110b of the second body 100b. Where the third portion 113c is not provided, the end portions on the Y′-direction side of the first portion 111c and the second portion 112c of the coupling body 110c are fixed to the lower portion 110b of the second body 100b. The projecting portion 120c and the pair of reinforcing portions 130c are omitted.

(5) The coupling body 110c of the coupling part 100c has the same configuration as the coupling body 110c of the coupling part 100c of configuration (1) described above, except that the coupling body 110c of the coupling part 100c is provided separately from either one of the first body 100a and the second body 100b (not illustrated).

Where the coupling body 110c is provided separately from the first body 100a, the fourth portion 114c (an end portion on the Y-direction side) of the coupling body 110c is fixed to the portion on the X-direction side of the upper portion 112a of the base 110a of the first body 100a and the fifth portion 115c (another end portion on the Y-direction side) of the coupling body 110c is fixed to the portion on the X′-direction side of the upper portion 112a of the base 110a of the first body 100a. In this case, it is optional whether to provide the projecting portion 120c and/or the pair of reinforcing portions 130c.

Where the coupling body 110c is provided separately from the second body 100b and the third portion 113c of the coupling body 110c is provided, the third portion 113c (the end portion on the Y′-direction side) of the coupling body 110c is fixed to the lower portion 110b of the second body 100b. Where the coupling body 110c is provided separately from the second body 100b and the third portion 113c is not provided, the end portion on the Y′-direction side of the first portion 111c and the end portion on the Y′-direction side of the second portion 112c of the coupling body 110c are fixed to the lower portion 110b of the second body 100b. In either of the former and latter cases, the projecting portion 120c and the pair of reinforcing portions 130c are omitted.

(6) The coupling body 110c of the coupling part 100c has the same configuration as the coupling body 110c of the coupling part 100c of configuration (2) described above, except that the coupling body 110c of the coupling part 100c is provided separately from either one of the first body 100a and the second body 100b (not illustrated).

Where the coupling body 110c is provided separately from the first body 100a, the end portion on the Y-direction side of the first portion 111c and the end portion on the Y-direction side of the second portion 112c of the coupling body 110c are fixed to the upper portion 112a of the base 110a of the first body 100a. In this case, it is optional whether to provide the projecting portion 120c and/or the pair of reinforcing portions 130c.

Where the coupling body 110c is provided separately from the second body 100b and the third portion 113c of the coupling body 110c is provided, the third portion 113c (the end portion on the Y′-direction side) of the coupling body 110c is fixed to the lower portion 110b of the second body 100b. Where the coupling body 110c is provided separately from the second body 100b and the third portion 113c is not provided, the end portion on the Y′-direction side of the first portion 111c and the end portion on the Y′-direction side of the second portion 112c of the coupling body 110c are fixed to the lower portion 110b of the second body 100b. In either of the former and latter cases, the projecting portion 120c and the pair of reinforcing portions 130c are omitted.

The first connector part C1a further includes a shell 300a having electrical conductivity. The shell 300a may be constituted by an electrically conductive material (e.g., a metal, a carbon material, such as a carbon nanotube, or the like material). For example, the shell 300a may be formed from a metal plate through sheet metal processing, or constituted by cast metal, or constituted by an electrically conductive material created using a 3D printer. Alternatively, the shell 300a may be constituted by an insulating material (e.g., an insulating resin or the like material) and a metal film plated or vapor-deposited on an inner surface and/or an outer surface of the insulating material.

The shell 300a includes a shell body 310a, which covers a part of an outer face of the first body 100a. For example, the shell body 310a may cover at least one of an outer face on the X-direction side, an outer face on the X′-direction side, an outer face on the Y-direction side, and an outer face on the Y′-direction side of the first body 100a, or a part thereof (a part of at least one of the outer faces). Alternatively, the shell body 310a may, for example, be generally shaped like a tube (generally shaped like a circular-section tube or a polygonal-section tube) with its central axis extending in the Z-Z′ direction and cover at least a part of an outer peripheral face (the outer face) of the first body 100a. In the latter case, the shell body 310a may have one of the following configurations (a) to (d).

(a) The shell body 310a is generally shaped like a tube and covers the outer peripheral face (outer face) of the upper portion 112a of the base 110a of the first body 100a (see FIGS. 1A to 1F, 2A, and 2C). The shell body 310a fits over the upper portion 112a of the base 110a of the first body 100a from the Z-direction side. The shell body 310a has an outer shape and outer dimensions that correspond to those of the upper portion 112a of the base 110a of the first body 100a in the cross section along the X-X′ and Z-Z′ directions.

(b) The shell body 310a is generally shaped like a tube and covers not only the outer peripheral face of the upper portion 112a of the base 110a but also the outer peripheral face (outer face) of the distal portion 120a of the first body 100a (not illustrated). The shell body 310a fits over the upper portion 112a of the base 110a and the distal portion 120a of the first body 100a from the Z-direction side. The shell body 310a has an outer shape and outer dimensions that correspond to those of the upper portion 112a of the base 110a of the first body 100a in the cross section along the X-X′ and Z-Z′ directions and correspond to those of the distal portion 120a of the first body 100a in the cross section along the X-X′ and Z-Z′ directions.

(c) The shell body 310a is generally shaped like a tube and covers the outer peripheral face (outer face) of the base 110a (the lower portion 111a and the upper portion 112a) of the first body 100a (not illustrated). The shell body 310a fits over the base 110a of the first body 100a from the Z-direction side. The shell body 310a has an outer shape and outer dimensions that correspond to those of the base 110a of the first body 100a in a cross section along the X-X′ and Z-Z′ directions. Where the first body 100a is provided with the first notch 140a, the shell body 310a is provided with third notch (not illustrated). The third notch extends through the shell body 310a in the same direction as the direction in which the first notch 140a extends through the lower portion 111a of the base 110a. The third notch communicates with the first notch 140a. The third notch opens in the Z′ direction.

(d) The shell body 310a is generally shaped like a tube and covers not only the outer peripheral face of the base 110a (the lower portion 111a and the upper portion 112a) of the first body 100a but also covers the outer peripheral face of the distal portion 120a (not illustrated). The shell body 310a fits over the base 110a and the distal portion 120a of the first body 100a from the Z-direction side. The shell body 310a has an outer shape and outer dimensions that correspond to those of the base 110a of the first body 100a in the cross section along the X-X′ and Z-Z′ directions and correspond to those of the distal portion 120a of the first body 100a in the cross section along the X-X′ and Z-Z′ directions. Where the first body 100a is provided with the first notch 140a, the shell body 310a is provided with the third notch described above.

Where the plurality of first notches 140a are provided, a plurality of third notches are provided corresponding to the number of the first notches 140a.

Where the coupling part 100c has configuration (1), (3), or (5) described above, a first recessed portion 311a and a second recessed portion 312a may be provided in a portion on the X-direction side and a portion on the X′-direction side, respectively, of the shell body 310a including one of configurations (a) to (d) described above. The first recessed portion 311a extends through the portion on the X-direction side of the shell body 310a in the X-X′ direction and opens out in the Z′ direction. The second recessed portion 312a extends through the portion on the X′-direction side of the shell body 310a in the X-X′ direction and opens out in the Z′ direction. The shell body 310a includes a portion on the Y′-direction side between the first recessed portion 311a and the second recessed portion 312a and a portion on the Y-direction side between the first recessed portion 311a and the second recessed portion 312a.

Where the first slit 114c1 and the second slit 115c1 are provided, an edge on the Z-direction side of the first recessed portion 311a and an edge on the Z-direction side of the second recessed portion 312a are respectively received in the first slit 114c1 and the second slit 115cl from the Z-direction side and respectively abut the bottom of the first slit 114c1 and the bottom of the second slit 115c1 from the Z-direction side, and the first boundary portion and the second boundary portion are respectively received in the first recessed portion 311a and the second recessed portion 312a from the Z′-direction side. The portion on the Y′-direction side between the first recessed portion 311a and the second recessed portion 312a of the shell body 310a is disposed in the through hole 101c of the coupling part 100c.

Where the engaging hole 116c extends from the bottom of one of, or each of, the first slit 114c1 and the second slit 115c1, an engaging piece 313a extends in the Z′ direction from the edge on the Z-direction side of one of, or each of, the first recessed portion 311a and the second recessed portion 312a. The or each engaging piece 313a is received and press-fitted in the or a corresponding engaging hole 116c.

Where neither the first slit 114c1 nor the second slit 115c1 is provided, the first boundary portion and the second boundary portion are respectively received in the first recessed portion 311a and the second recessed portion 312a from the Z′-direction side, and the edge on the Z-direction side of the first recessed portion 311a and the edge on the Z-direction side of the second recessed portion 312a respectively abut the first boundary portion and the second boundary portion from the Z-direction side. The portion on the Y′-direction side between the first recessed portion 311a and the second recessed portion 312a of the shell body 310a is disposed in the through hole 101c of the coupling part 100c. Where the engaging hole 116c is provided in the face on the Z-direction side of one of, or each of, the first boundary portion and the second boundary portion, the or each engaging piece 313a is received and press-fitted in the or a corresponding engaging hole 116c.

Where the coupling part 100c has configuration (2), (4), or (6) described above, a third recessed portion and a fourth recessed portion (not illustrated) may be provided at two positions on the Y′-direction side of the shell body 310a including one of configurations (a) to (d) described above. The third recessed portion and the fourth recessed portion extend through the two portions of the shell body 310a in the Y-Y′ direction and open in the Z′ direction. The shell body 310a includes a portion on the Y′-direction side between the third recessed portion and the fourth recessed portion and a portion on the Y-direction side between the third recessed portion and the fourth recessed portion.

Where the third and fourth slits are provided, an edge on the Z-direction side of the third recessed portion and an edge on the Z-direction side of the fourth recessed portion are respectively received in the third slit and the fourth slit from the Z-direction side and respectively abut the bottom of the third slit and the bottom of the fourth slit from the Z-direction side, and the third boundary portion and the fourth boundary portion are respectively received in the third recessed portion and the fourth recessed portion from the Z′-direction side. The portion on the Y′-direction side between the third recessed portion and the fourth recessed portion of the shell body 310a is disposed in the through hole 101c of the coupling part 100c. Where the engaging hole 116c extends from the bottom of one of, or each of, the third slit and the fourth slit, an engaging piece 313a extends in the Z′ direction from an edge on the Z-direction side of one of, or each of, the first recessed portion 311a and the second recessed portion 312a. The or each engaging piece 313a is received and press-fitted in the or a corresponding engaging hole 116c.

Where neither the third slit nor the fourth slit is provided, the third boundary portion and the fourth boundary portion are respectively received in the third recessed portion and the fourth recessed portion from the Z′-direction side, and the edge on the Z-direction side of the third recessed portion and the edge on the Z-direction side of the fourth recessed portion respectively abut the third boundary portion and the fourth boundary portion from the Z-direction side. The portion on the Y′-direction side between the third recessed portion and the fourth recessed portion of the shell body 310a is disposed in the through hole 101c of the coupling part 100c. Where the engaging hole 116c is provided in the face on the Z-direction side of one of, or each of, the third boundary portion and the fourth boundary portion, the or each engaging piece 313a is received and press-fitted in the or a corresponding engaging hole 116c.

The shell body 310a may be configured such that the first recessed portion 311a and the second recessed portion 312a are omitted, and that the shell body 310a abuts the first boundary portion and the second boundary portion from the Z-direction side. Alternatively, the shell body 310a may be configured such that the third recessed portion and the fourth recessed portion are omitted, and that the shell body 310a abuts the third boundary portion and the fourth boundary portion from the Z-direction side.

Where the shell body 310a has configuration (a) or (c) described above, the shell 300a may further include a plurality of strips 320a. The strips 320a extend in the Z direction from the shell body 310a and are spaced from each other in the circumferential direction of the shell body 310a. The plurality of strips 320a face the outer peripheral face of the distal portion 120a of the first body 100a with a gap therebetween. The plurality of strips 320a are bent such that distal portions thereof protrude outward. Where the shell body 310a has configuration (b) or (d) described above, the plurality of strips 320a are omitted. Also where the shell body 310a has configuration (a) or (c) described above, the plurality of strips 320a can be omitted.

The shell 300a further includes at least one third mountable portion 331a. The at least one third mountable portion 331a may be a single third mountable portion or a plurality of third mountable portions. For convenience of description, the at least one third mountable portion 331a will be described as a plurality of third mountable portion 331a. However, also where a single third mountable portion 331a is provided, it may be configured similarly to each of the third mountable portions 331a described below.

Each of the third mountable portions 331a may be a surface-mount type.

Where the shell body 310a has configuration (a) or (b) described above, each of the third mountable portions 331a is a generally L-shaped plate, extends from the shell body 310a in the Z′ direction, and then extends toward the through hole 101c of the coupling part 100c (e.g., extends in the Y′ direction, the first oblique direction, or the second oblique direction).

Where the shell body 310a has configuration (c) or (d) described above, each of the third mountable portions 331a may be generally L-shaped plates, extend from the shell body 310a in the Z′ direction, and then extend toward the through hole 101c of the coupling part 100c (e.g., extend in the Y′ direction, the first oblique direction, or the second oblique direction). Alternatively, each of the third mountable portions 331a may extend from the shell body 310a toward the through hole 101c (e.g., may extend in the Y′ direction, the first oblique direction, or the second oblique direction).

Where the face on the Z′-direction side of the coupling body 110c is located on the Z′-direction side relative to the face on the Z′-direction side of the first body 100a, entireties, or parts on the Z′-direction side, of the plurality of third mountable portions 331a are disposed on the Z′-direction side relative to the through hole 101c of the coupling part 100c (see FIGS. 1A to 2F). Where the face of the coupling body 110c on the Z′-direction side is located at substantially the same height position as the face on the Z′-direction side of the first body 100a in the Z-Z′ direction (not illustrated), entireties, or parts on the Z′-direction side, of the plurality of third mountable portions 331a are disposed in the through hole 101c of the coupling part 100c. The plurality of third mountable portions 331a are thus visually recognizable from the Z-direction side through the through hole 101c.

The shell 300a may further include at least one fourth mountable portion 332a. The at least one fourth mountable portion 332a may be a single fourth mountable portion or a plurality of fourth mountable portions. For convenience of description, the at least one fourth mountable portion 332a will be described as a plurality of fourth mountable portions 332a. However, also where a single fourth mountable portion 332a is provided, it may be configured similarly to each of the fourth mountable portions 332a described below.

Each of the fourth mountable portions 332a may be a surface-mount type.

Where the shell body 310a has configuration (a) or (b) described above, each of the fourth mountable portions 332a is a generally L-shaped plate, extends in the Z′ direction from the shell body 310a, and then extends in the Y direction, the X direction, the X′ direction, the third oblique direction, or the fourth oblique direction.

Where the shell body 310a has configuration (c) or (d) described above, each of the fourth mountable portions 332a may be a generally L-shaped plate, extend from the shell body 310a in the Z′ direction, and then extend in the Y direction, the X direction, the X′ direction, the third oblique direction, or the fourth oblique direction. Alternatively, each of the fourth mountable portions 332a may extend in the Y direction, the X direction, the third oblique direction, or the fourth oblique direction from the shell body 310a.

In any of the configurations described above, the plurality of fourth mountable portions 332a are disposed on the Y-direction side relative to the through hole 101c of the coupling part 100c (see FIGS. 1A to 2F). The faces on the Z′-direction side of the plurality of fourth mountable portions 332a and the faces on the Z′-direction side of the plurality of third mountable portions 331a are located at substantially the same height position in the Z-Z′ direction. The faces on the Z′-direction side of the plurality of fourth mountable portions 332a and the faces on the Z′-direction side of the plurality of third mountable portions 331a may be located at substantially the same height position as the face on the Z′-direction side of the first body 100a in the Z-Z′ direction, or alternatively located on the Z′-direction side relative to the face on the Z′-direction side of the first body 100a. The at least one fourth mountable portion 332a can be omitted.

The first connector part C1a further includes at least one first terminal 200a. The at least one first terminal 200a may be a single first terminal 200a or a plurality of first terminals 200a. For convenience of description, the at least one first terminal 200a will be described as a single first terminal 200a. However, also where a plurality of first terminals 200a are provided, each of the first terminal 200a may be configured similarly to the first terminal 200a described below.

The first terminal 200a is constituted by an electrically conductive material (e.g., a metal, a carbon material, such as a carbon nanotube, or the like material). The first terminal 200a includes a first retainable portion 210a, a first contacting portion 220a, and a first mountable portion 230a.

The first retainable portion 210a is a portion of the first terminal 200a between the first contacting portion 220a and the first mountable portion 230a. For example, the first retainable portion 210a is constituted by a generally tubular plate extending in the Z-Z′ direction (see FIGS. 2A, and 2C to 3B), a generally U-shaped plate extending in the Z-Z′ direction (not illustrated), a plate or rod extending in the Z-Z′ direction (not illustrated), or the like. The first retainable portion 210a has an outer shape and outer dimensions in a cross section along the X-X′ and Y-Y′ directions that respectively correspond to a shape and dimensions of the first housing hole 130a of the first body 100a in the cross section along the X-X′ and Y-Y′ directions. The first retainable portion 210a is fittingly received in the first housing hole 130a of the first body 100a from the Z′-direction side. The first retainable portion 210a is thus retained in the first housing hole 130a of the first body 100a.

The first contacting portion 220a extends in the Z direction from the first retainable portion 210a and is exposed at least partly from the first body 100a. For example, the first contacting portion 220a extends in the Z direction from the first retainable portion 210a and is constituted by a pair of beams (see FIGS. 2A, 3A, and 3B), a rod (not illustrated), a flat plate (not illustrated), a tube (not illustrated), or the like. The first contacting portion 220a is housed in the first housing hole 130a of the first body 100a and partly exposed from the first opening 131a of the first housing hole 130a.

The central axis of the first retainable portion 210a and/or the first contacting portion 220a of the first terminal 200a may be disposed along the central axis of the first body 100a and/or the central axis of the shell body 310a of the shell 300a. Where the first retainable portion 210a and the first contacting portion 220a of the first terminal 200a are arranged substantially coaxially with the first body 100a and the shell body 310a, the first connector part C1a forms a coaxial connector. In this case, the first terminal 200a serves as a central conductor of the coaxial connector, and the shell 300a serves as an outer conductor of the coaxial connector. The first retainable portion 210a and the first contacting portion 220a of the first terminal 200a may be arranged such that the first retainable portion 210a and the first contacting portion 220a are substantially coaxial with neither the first body 100a nor the shell body 310a of the shell 300a.

The first mountable portion 230a is at least partly located, relative to the first body 100a, on the Z′-direction side, the Y-direction side, the X-direction side, the X′-direction side, the first-oblique-direction side, the second-oblique-direction side, the third-oblique-direction side, or the fourth-oblique-direction side. The first mountable portion 230a may be a surface-mount type.

Where the shell body 310a of the shell 300a has configuration (a) or (b) described above, the first mountable portion 230a may be a generally L-shaped rod or plate, extend from the first retainable portion 210a in the Z′ direction, and then extend in the Y direction, the X direction, the X′ direction, the first oblique direction, the second oblique direction, the third oblique direction, or the fourth oblique direction (see FIGS. 1A to 3B). Alternatively, the first mountable portion 230a may be a straight rod or plate and extend from the first retainable portion 210a in the Y direction, the X direction, the X′ direction, the first oblique direction, the second oblique direction, the third oblique direction, or the fourth oblique direction (not illustrated). In either case, the first mountable portion 230a of the first terminal 200a extends through the first notch 140a of the first body 100a and on the Z′-direction side relative to the shell body 310a, and a distal portion of the first mountable portion 230a is located, relative to the first body 100a and the shell body 310a, on the Y-direction side (not illustrated), the X-direction side (not illustrated), the X′-direction side (see FIGS. 1i, 1D to 1F, and 2C), the first-oblique-direction side (not illustrated), the second-oblique-direction side (not illustrated), the third-oblique-direction side (not illustrated), or the fourth-oblique-direction side (not illustrated).

Where the shell body 310a of the shell 300a has configuration (c) or (d) described above, the first mountable portion 230a is the generally L-shaped rod or plate described above or the straight rod or plate described above and extends through the first notch 140a of the first body 100a and the third notch of the shell body 310a, and the distal portion of the first mountable portion 230a is located on the Y-direction side, the X-direction side, or the X′-direction side relative to the first body 100a and the shell body 310a (not illustrated).

The first mountable portion 230a of any of the configurations described above includes a face on the Z′-direction side, which is located in the Z-Z′ direction at substantially the same height position as the faces on the Z′-direction side of the plurality of third mountable portions 331a of the shell 300a and the faces on the Z′-direction side of the plurality of fourth mountable portions 332a (if provided).

The plurality of third mountable portions 331a and the plurality of fourth mountable portions 332a occupies different positions from the first mountable portion 230a so as not to coincide with the first mountable portion 230a. Some possible positions are as follows.

Where the distal portion of the first mountable portion 230a of the first terminal 200a is located on the Y-direction side relative to the first body 100a and the shell body 310a and the plurality of fourth mountable portions 332a of the shell 300a are provided, each fourth mountable portion 332a of the shell 300a may extend from the shell body 310a in the Z′ direction, and then extend in the X direction, the X′ direction, the third oblique direction, or the fourth oblique direction, or alternatively, each fourth mountable portion 332a may extend from the shell body 310a in the X direction, the X′ direction, the third oblique direction, or the fourth oblique direction.

Where the distal portion of the first mountable portion 230a of the first terminal 200a is located on the X-direction side relative to the first body 100a and the shell body 310a and the plurality of fourth mountable portions 332a of the shell 300a are provided, each fourth mountable portion 332a of the shell 300a may extend from the shell body 310a in the Z′ direction, and then extend in the Y direction, the X′ direction, the third oblique direction, or the fourth oblique direction, or alternatively, each fourth mountable portion 332a may extend from the shell body 310a in the Y direction, the X′ direction, the third oblique direction, or the fourth oblique direction.

Where the distal portion of the first mountable portion 230a of the first terminal 200a is located on the X′-direction side relative to the first body 100a and the shell body 310a and the plurality of fourth mountable portions 332a of the shell 300a are provided, each fourth mountable portion 332a of the shell 300a may extend from the shell body 310a in the Z′ direction, and then extend in the Y direction, the X direction, the third oblique direction, or the fourth oblique direction, or alternatively, each fourth mountable portion 332a may extend from the shell body 310a in the Y direction, the X direction, the third oblique direction, or the fourth oblique direction.

The second connector part C1b further includes at least one second terminal 200b. The at least one second terminal 200b may be a single second terminal 200b or a plurality of second terminals 200b. For convenience of description, the at least one second terminal 200b will be described as a plurality of second terminals 200b. However, also where a single second terminal 200b is provided, it may be configured similarly to each of second terminals 200b described below.

Each of the second terminals 200b is constituted by an electrically conductive material (e.g., a metal, a carbon material, such as a carbon nanotube, or the like material). Each of the second terminals 200b may be used for signal transmission, power transmission, grounding, or any other use. Each of the second terminals 200b includes a second retainable portion 210b, a second contacting portion 220b, and a second mountable portion 230b.

The second retainable portion 210b of each second terminal 200b is a portion of the second terminal 200b between the second contacting portion 220b and the second mountable portion 230b. For example, the second retainable portion 210b is constituted by a generally tubular plate extending in the Z-Z′ direction (see FIGS. 2B, and 2D to 3B), a generally U-shaped plate extending in the Z-Z′ direction (not illustrated), a plate or rod extending in the Z-Z′ direction (not illustrated), or the like. The second retainable portion 210b has an outer shape and outer dimensions in a cross section along the X-X′ and Y-Y′ directions that respectively correspond to a shape and dimensions of a corresponding one of the second housing holes 130b of the second body 100b in the cross section along the X-X′ and Y-Y′ directions. The second retainable portion 210b is fittingly received in the corresponding second housing hole 130b of the second body 100b from the Z′-direction side. The second retainable portion 210b is thus retained in the corresponding second housing hole 130b of the second body 100b. The second retainable portion 210b includes a face on the Z′-direction side, which may be located in the Z-Z′ direction at substantially the same height position as the face on the Z′-direction side of the second body 100b (see FIGS. 2B and 2D), or alternatively may be located on the Z-direction side relative to the face on the Z′-direction side of the second body 100b (not illustrated).

The second contacting portion 220b of each second terminal 200b extends in the Z direction from the second retainable portion 210b and is exposed at least partly from the second body 100b. For example, the second contacting portion 220b extends in the Z direction from the second retainable portion 210b and is constituted by a pair of beams (see FIGS. 2B, 3A, and 3B), a rod (not illustrated), a flat plate (not illustrated), a tube (not illustrated), or the like. The second contacting portion 220b is housed in the corresponding second housing hole 130b of the second body 100b and partly exposed from the first opening 131b of the corresponding second housing hole 130b.

The second mountable portion 230b of each second terminal 200b is at least partly located, relative to the second body 100b, on the Z′-direction side, the Y′-direction side, the X-direction side, the X′-direction side, the first-oblique-direction side, the second-oblique-direction side, the third-oblique-direction side, or the fourth-oblique-direction side. The second mountable portion 230b of each of the second terminals 200b may be a surface-mount type.

Where the face on the Z′-direction side of the second body 100b is located on the Z-direction side relative to the face on the Z′-direction side of the first body 100a, the second mountable portion 230b of each second terminal 200b is a generally L-shaped rod or plate, extends from the second retainable portion 210b in the Z′ direction, and then extends in the Y′ direction, the X direction, the X′ direction, the first oblique direction, the second oblique direction, the third oblique direction, or the fourth oblique direction (see FIGS. 1A to 1D, 1F, and 2D). The second mountable portion 230b of each second terminal 200b is at least partly located on the Z′-direction side relative to the face on the Z′-direction side of the second body 100b.

Where the face on the Z′-direction side of the second body 100b is located at substantially the same height position as the face on the Z′-direction side of the first body 100a, the second mountable portion 230b of each second terminal 200b may be a generally L-shaped rod or plate, and extend in the Z′ direction from the second retainable portion 210b, and then extend in the Y′ direction, the X direction, the X′ direction, the first oblique direction, the second oblique direction, the third oblique direction, or the fourth oblique direction (not illustrated). Alternatively, the second mountable portion 230b of each second terminal 200b may be a straight rod or plate and extend from the second retainable portion 210b in the Y′ direction, the X direction, the X′ direction, the first oblique direction, the second oblique direction, the third oblique direction, or the fourth oblique direction (not illustrated). In either case, the second mountable portion 230b extends through the corresponding second notch of the second body 100b, and a distal portion of the second mountable portion 230b is located, relative to the second body 100b, on the Y′-direction side, the X-direction side, the X′-direction side, the first-oblique-direction side, the second-oblique-direction side, the third-oblique-direction side, or the fourth-oblique-direction side.

The second mountable portion 230b of any of the configurations described above of each second terminal 200b includes a face on the Z′-direction side, which is located in the Z-Z′ direction at substantially the same height position as the face on the Z′-direction side of the first mountable portion 230a.

Each second terminal 200b may further include a positioning portion 240b and a plurality of joining portions 250b. The positioning portion 240b is disposed in spaced relation to, and on the Z-direction side relative to, the second contacting portion 220b. The positioning portion 240b is constituted by a generally tubular plate extending in the Z-Z′ direction (see FIGS. 2B, and 2D to 3B), a generally U-shaped plate extending in the Z-Z′ direction (not illustrated), a plate or rod extending in the Z-Z′ direction (not illustrated), or the like. The positioning portion 240b has an outer shape and outer dimensions in a cross section along the X-X′ and Y-Y′ directions that respectively correspond to a shape and dimensions of the corresponding second housing hole 130b of the second body 100b in the cross section along the X-X′ and Y-Y′ directions. The positioning portion 240b is received, press-fitted, and retained in the corresponding second housing hole 130b of the second body 100b from the Z′-direction side.

The plurality of joining portions 250b of each second terminal 200b extend from the second retainable portion 210b to the positioning portion 240b. The positioning portion 240b and the plurality of joining portions 250b can be omitted.

The following is a description of a non-limiting method for manufacturing the connector C1. The first body 100a and the second body 100b are prepared which are coupled by the coupling part 100c.

The shell 300a is prepared. The shell body 310a of the shell 300a is fitted over at least a part of the first body 100a from the Z-direction side in a manner described above. Where the shell 300a includes the plurality of strips 320a, the shell body 310a is fitted over the upper portion 112a of the base 110a of the first body 100a, or alternatively over the base 110a of the first body 100a, and the plurality of strips 320a are arranged to face the distal portion 120a of the first body 100a with a gap therebetween. Where the shell 300a does not include the plurality of strips 320a, the shell body 310a is fitted over the upper portion 112a of the base 110a and the distal portion 120a of the first body 100a, or alternatively over the base 110a and the distal portion 120a of the first body 100a.

In one of the above-described fitting steps of the shell body 310a, the entireties, or the parts on the Z′-direction side, of the plurality of third mountable portions 331a are passed through the through hole 101c of the coupling part 100c from the Z-direction side, and disposed on the Z′-direction side relative to the through hole 101c or alternatively disposed in the through hole 101c.

Where the first boundary portion and the second boundary portion between the first body 100a and the coupling part 100c are respectively provided with the first slit 114c1 and the second slit 115c1, and the engaging hole 116c extends from the bottom of one of, or each of, the first slit 114c1 and the second slit 115c1, in one of the above-described fitting steps of the shell body 310a, the edge on the Z-direction side of the first recessed portion 311a and the edge on the Z-direction side of the second recessed portion 312a of the shell body 310a are respectively inserted into the first slit 114c1 and the second slit 115c1 from the Z-direction side, and the first boundary portion and the second boundary portion are respectively inserted into the first recessed portion 311a and the second recessed portion 312a from the Z′-direction side, and the or each engaging piece 313a of the shell body 310a is inserted into the or a corresponding engaging hole 116c and hooked onto a wall or a corresponding wall of the engaging hole 116c. Where neither the or a corresponding engaging hole 116c nor the or each engaging piece 313a is provided, the step of inserting the or each engaging piece 313a into the or a corresponding engaging hole 116c is omitted. Where neither the or a corresponding engaging hole 116c nor the or each engaging piece 313a and neither the first slit 114c1 nor the second slit 115c1 is provided, in one of the above-described fitting steps of the shell body 310a, the first boundary portion and the second boundary portion are respectively inserted into the first recessed portion 311a and the second recessed portion 312a of the shell body 310a from the Z′-direction side.

Where the third boundary portion and the fourth boundary portion between the first body 100a and the coupling part 100c are respectively provided with the third slit and the fourth slit, and the engaging hole 116c extends from the bottom of one of, or each of, the third slit and the fourth slit, in one of the above-described fitting steps of the shell body 310a, the edge on the Z-direction side of the third recessed portion and the edge on the Z-direction side of the fourth recessed portion of the shell body 310a are respectively inserted into the third slit and the fourth slit from the Z-direction side, and the third boundary portion and the fourth boundary portion are respectively inserted into the third recessed portion and the fourth recessed portion from the Z′-direction side, and the or each engaging piece 313a of the shell body 310a is inserted and press-fitted into the or a corresponding engaging hole 116c. Where neither the or a corresponding engaging hole 116c nor the or each engaging piece 313a is provided, the step of inserting the or each engaging piece 313a into the or a corresponding engaging hole 116c is omitted. Where neither the or a corresponding engaging hole 116c nor the or each engaging piece 313a and the third slit nor the fourth slit is provided, in one of the above-described fitting steps of the shell body 310a, the third boundary portion and the fourth boundary portion are respectively inserted into the third recessed portion and the fourth recessed portion of the shell body 310a from the Z′-direction side.

Thus the shell 300a is attached to the first body 100a.

The first terminal 200a is prepared. The first contacting portion 220a and the first retainable portion 210a of the first terminal 200a are inserted into the first housing hole 130a of the first body 100a, and the first retainable portion 210a is retained in the first housing hole 130a. At this time, the first mountable portion 230a of the first terminal 200a is inserted into the first notch 140a of the first body 100a, or alternatively into the first notch 140a of the first body 100a and the third notch of the shell 300a, from the Z′-direction side, and the distal portion of the first mountable portion 230a is disposed, relative to the first body 100a and the shell body 310a, on the Y-direction side, the X-direction side, the X′-direction side, the first-oblique-direction side, the second-oblique-direction side, the third-oblique-direction side, or the fourth-oblique-direction side.

The plurality of second terminals 200b are prepared.

Where each of the second terminals 200b includes the positioning portion 240b and the plurality of joining portions 250b, the positioning portion 240b, the plurality of joining portions 250b, the second contacting portion 220b, and the second retainable portion 210b of each second terminal 200b are inserted into the corresponding one of the second housing holes 130b, and the positioning portion 240b and the second retainable portion 210b are press-fitted and retained into the corresponding second housing hole 130b. Where each of the second terminals 200b includes neither the positioning portion 240b nor the plurality of joining portions 250b, the second contacting portion 220b and the second retainable portion 210b of each second terminal 200b are inserted into the corresponding one of the second housing holes 130b, and the second retainable portion 210b is retained in the corresponding second housing hole 130b.

In either case, when each second terminal 200b has been inserted into the corresponding second housing hole 130b, the second mountable portion 230b of each second terminal 200b is at least partly located on the Z′-direction side relative to the second body 100b, or alternatively the second mountable portion 230b of each second terminal 200b is receive in the corresponding one of the second notches of the second body 100b from the Z′-direction side, and the distal portion of the second mountable portion 230b is located, relative to the second body 100b, on the Y′-direction side, the X-direction side, the X′-direction side, the first-oblique-direction side, the second-oblique-direction side, the third-oblique-direction side, or the fourth-oblique-direction side. The second retainable portions 210b of the plurality of second terminals 200b are arranged in the second body 100b, in spaced relation to each other in the X-X′ direction and/or the Y-Y′ direction, corresponding to the positions of the second retainable portions 210b.

Thus the connector C1 is manufactured.

The step of attaching the shell body 310a of the shell 300a to the first body 100a, the step of inserting the first terminal 200a into the first housing hole 130a, and the step of inserting the second terminals 200b into the second housing holes 130b may be carried out in any order.

The following is a description of a method of surface mounting the connector C1 onto a circuit board (not illustrated). The circuit board may be a rigid circuit board or a flexible circuit board. The circuit board may be a single-sided circuit board, a double-sided circuit board, or a multilayer circuit board. On a surface on the Z-direction side of the circuit board is provided a first surface electrode, a plurality of second surface electrodes, one or a plurality of third surface electrodes (GND electrode or electrodes), and one or a plurality of fourth surface electrodes (GND electrode or electrodes). The Z-Z′ direction is also the diction in which the connector C1 is mounted onto the circuit board.

The connector C1 is brought relatively closer to the circuit board in the Z-Z′ direction and placed on the circuit board. At this time, the first mountable portion 230a of the first terminal 200a of the first connector part C1a of the connector C1 is placed on the first surface electrode of the circuit board, the plurality of third mountable portions 331a of the shell body 310a of the first connector part C1a of the connector C1 are placed on the one or plurality of third surface electrodes of the circuit board, the plurality of fourth mountable portions 332a of the shell body 310a of the first connector part C1a of the connector C1 are placed on the one or plurality of fourth surface electrodes of the circuit board, and the second mountable portions 230b of the plurality of second terminals 200b of the second connector part C1b of the connector C1 are placed on the respective second surface electrodes of the circuit board. Thereafter, by a soldering method (e.g. reflow soldering) or other known connection method, the first mountable portion 230a of the first terminal 200a of the first connector part C1a of the connector C1 is connected to the first surface electrode of the circuit board, the plurality of third mountable portions 331a of the shell body 310a of the first connector part C1a of the connector C1 are connected to the one or plurality of third surface electrodes of the circuit board, the plurality of fourth mountable portions 332a of the shell body 310a of the first connector part C1a of the connector C1 are connected to the one or plurality of fourth surface electrodes of the circuit board, and the second mountable portions 230b of the plurality of second terminals 200b of the second connector part C1b of the connector C1 are connected to the respective second surface electrodes of the circuit board. Thus the first connector part C1a and the second connector part C1b of the connector C1 are surface-mounted in position on the circuit board. Where the plurality of fourth mountable portions 332a are omitted, the one or plurality of fourth surface electrodes of the circuit board are also omitted.

The provision of the through hole 101c in the coupling part 100c makes it possible to check the mounting condition of the plurality of third mountable portions 331a of the shell 300a from the Z-direction side through the through hole 101c.

The following is a description of a non-limiting method of connecting the connector C1 to a mating connector (not illustrated). The mating connector may be a cable connector, or may be an intermediate connector to intermediate a cable connector and the connector C1. The mating connector includes a third connector part and a fourth connector part. The third connector part includes a coaxial connector part and a coaxial cable. The fourth connector includes a multicore connector part and a multicore cable.

The connector C1 and the mating connector are brought relatively close to each other in the Z-Z′ direction. Where the shell 300a of the first connector part C1a of the connector C1 includes the plurality of strips 320a, the strips 320a of the shell 300a of the first connector part C1a are inserted into, and brought into elastic contact with, an tubular shell body of the third connector part of the mating connector, and a contacting portion of a third terminal of the third connector part is inserted into the first housing hole 130a of the first body 100a of the first connector part C1a and brought into contact with the first contacting portion 220a of the first terminal 200a of the first connector part C1a. Where the shell 300a of the first connector part C1a of the connector C1 does not include the plurality of strips 320a, the shell body 310a of the shell 300a of the first connector part C1a is inserted into, and brought into elastic contact with, the shell body of the third connector part of the mating connector, and the contacting portion of the third terminal of the third connector part is inserted into the first housing hole 130a of the first body 100a of the first connector part C1a and brought into contact with the first contacting portion 220a of the first terminal 200a of the first connector part C1a. Thus the first connector part C1a is connected to the third connector part of the mating connector.

Together with the connection of the first connector part C1a to the third connector part of the mating connector, the second body 100b of the second connector part C1b of the connector C1 may be inserted between first, second, and third retaining arms of the fourth connector part of the mating connector, and retained by the first, second, and third retaining arms from the Y′-direction side, the X-direction side, and the X′-direction side, respectively. Alternatively, the second body 100b of the second connector part C1b of the connector C1 may be fitted into a connection hole of the fourth connector part of the mating connector.

Where the second body 100b of the second connector part C1b is provided with the at least one key portion 150b, when the second body 100b of the second connector part C1b is inserted between the first, second, and third retaining arms of the fourth connector part of the mating connector, the at least one key portion 150b may be fitted into at least one key groove of the mating connector, or alternatively may be brought into contact with at least one of the second retaining arm or the third retaining arm of the mating connector from the Y′-direction side. Alternatively, when the second body 100b of the second connector part C1b is fitted into the connection hole of the fourth connector part of the mating connector, the at least one key portion 150b is fitted into the at least one key groove of the mating connector.

When the second body 100b of the second connector part C1b is inserted between the first, second, and third retaining arms of the fourth connector part of the mating connector or fitted into the connection hole of the fourth connector part of the mating connector, contacting portions of a plurality of fourth terminals of the fourth connector part of the mating connector are inserted into the plurality of second housing holes 130b of the second body 100b of the second connector part C1b and brought into contact with the second contacting portions 220b of the plurality of second terminals 200b. Thus the second connector part C1b is connected to the fourth connector part of the mating connector.

The coupling part 100c of the first connector part C1a of the connector C1 may be shaped such that it does not coincide with the shell body of the third connector part of the mating connector, in a state where the plurality of strips 320a or the shell body 310a of the shell 300a of the first connector part C1a are received in the shell body of the third connector part of the mating connector (this state may be referred to as a “connection state”). For example, where the coupling part 100c includes the projecting portion 120c and the pair of reinforcing portions 130c, each reinforcing portion 130c may have a generally right-angled triangular shape as described above or any other shape such that each reinforcing portion 130c does not coincide with the shell body of the third connector part of the mating connector in the connected state. Where the coupling part 100c includes the projecting portion 120c but not the pair of reinforcing portions 130c, the projecting portion 120c projects in the Y direction to such a degree that the projecting portion 120c does not coincide with the shell body of the third connector part of the mating connector in the connected state. Where the coupling part 100c includes neither the projecting portion 120c nor the pair of reinforcing portions 130c, the face on the Z-direction side of the coupling body 110c of the coupling part 100c may be at such a height position that the face on the Z-direction side does not coincide with the shell body of the third connector part of the mating connector in the connected state.

Where the shell 300a of the first connector part C1a of the connector C1 does not include the plurality of strips 320a, the shell body 310a of the shell 300a of the first connector part C1a may not be brought into elastic contact with the shell body of the third connector part of the mating connector, but with a plurality of strips extending from the shell body of the third connector part.

The hybrid connector C1 described above provides technical features and effects (1) to (7) below.

Technical feature and effect (1): The connector C1 is structured such that first body 100a of the first connector part C1a and the second body 100b of the second connector part C1b are coupled by the coupling part 100c. In each mount of the connector C1 on a circuit board, this structure reduces variations in respective absolute positions of the first connector part C1a and the second connector part C1b on the circuit board, and also reduces variations in relative positional relationship of the first connector part C1a and the second connector part C1b (e.g., the distance between, and/or the orientations of, the first connector part C1a and the second connector part C1b) on the circuit board.

Technical feature and effect (2): The conventional first and second connectors described above are separate connectors. Therefore, in each mount of the first and second connectors, variations occur in respective absolute positions of the first and second connectors and also in relative positional relationship of the first and second connectors. With such variations permitted, in order to securely connect the conventional first and second connectors respectively to the third and fourth connector parts of the mating connector, it is necessary to enlarge contacting portions of a plurality of terminals of the conventional second connector so as to allow a contacting portion of a terminal of the conventional first connector to contact the contacting portions of the third terminal of the third connector of the mating connector and allow the contacting portions of the terminals of the conventional second connector to securely contact the contacting portions of the plurality of fourth terminals of the fourth connector part of the mating connector. Such enlarged contacting portions of the terminals of the conventional second connector means increased distances between the terminals, resulting in increased size of the conventional second connector.

In contrast, as described above, the connector C1 is structured such as to reduce variations in respective absolute positions of the first connector part C1a and the second connector part C1b and also reduce variations in relative positional relationship of the first connector part C1a and the second connector part C1b. This structure obviates the necessity to enlarge the second contacting portions 220b of the plurality of second terminals 200b of the second connector part C1b of the connector C1, for the purpose of enabling the first connector part C1a and the second connector part C1b of the connector C1 to be connected to the third connector part and the fourth connector part of the mating connector. It is therefore possible to minimize the size of the second connector part C1b of the connector C1.

Technical feature and effect (3): The coupling part 100c is provided with the through hole 101c, and the entireties, or the parts on the Z′-direction side, of the plurality of third mountable portions 331a are arranged on the Z′-direction side relative to the through hole 101c (see FIGS. 1A to 2F) or arranged in the through hole 101c. It is therefore possible to check the mounting condition of the plurality of third mountable portions 331a of the shell 300a from the Z-direction side through the through hole 101c. Also, in addition to the first mountable portion 230a of the first terminal 200a and the second mountable portions 230b of the plurality of second terminals 200b being mounted on the circuit board, the plurality of third mountable portions 331a of the shell 300a are mounted on the circuit board, on the Z′-direction side relative to the through hole 101c of the coupling part 100c or in the through hole 101c (i.e., between the first body 100a and the second body 100b). This arrangement improves the peeling strength of the connector C1.

Technical feature and effect (4): Where the face on the Z′-direction side of the coupling body 110c of the coupling part 100c is located on the Z-direction side relative to the face on the Z′-direction side of the first body 100a, the entireties, or the parts on the Z′-direction side, of the plurality of third mountable portions 331a of the shell 300a can be disposed on the Z′-direction side relative to the through hole 101c of the coupling part 100c. In this case, in a state where the face on the Z′-direction side of the first body 100a is placed on the circuit board, there is a gap between the face on the Z′-direction side of the coupling body 110c of the coupling part 100c and the circuit board. In this gap are disposed the entireties, or the parts on the Z′-direction side, of the plurality of third mountable portions 331a. This allows easier connection of the plurality of third mountable portions 331a of the shell 300a to the one or plurality of third surface electrodes of the circuit board by a soldering method (e.g., reflow soldering) or other known connection method.

Technical feature and effect (5): Where the shell body 310a of the shell 300a fits over at least a part of an outer peripheral portion of the first body 100a from the Z-direction side and abuts the first and second boundary portions, or alternatively the third and fourth boundary portions, of the coupling body 110c between the first body 100a and the coupling part 100c from the Z-direction side as described above, the plurality of third mountable portions 331a of the shell 300a is mounted on the one or a plurality of third surface electrodes of the circuit board. This arrangement reduces the possibility that the first body 100a may fall off from the circuit board to the Z-direction side.

Technical feature and effect (6): The distal portion of the first mountable portion 230a of the first terminal 200a of the first connector part C1a is located on the Y-, X-, or X′-direction side relative to the first body 100a and the shell body 310a. This arrangement allows mounting an electronic component, such as an IC for the first connector part C1a, in the vicinity of, and on the Y-, X-, or X′-direction side relative to, the first body 100a and the shell body 310a on the circuit board, in a state where the first mountable portion 230a of the first terminal 200a is mounted on the first surface electrode of the circuit board. In addition, since the electronic component is thus disposed in the vicinity of the first body 100a and the shell body 310a, a connection line extending from the first surface electrode of the circuit board to the electronic component can have a simple geometry that has no or few stubs and that is unlikely to cause reflection of signals, and the connection line can be relatively short in length.

Technical feature and effect (7): Where the first mountable portion 230a of the first terminal 200a of the first connector part C1a extends from the first retainable portion 210a in the Z′ direction and then extends in the X or X′ direction, or alternatively where the first mountable portion 230a extends from the first retainable portion 210a in the X or X′ direction, the plurality of third mountable portions 331a of the shell 300a are arranged symmetrically in the Y-Y′ direction to the plurality of fourth mountable portions 332a of the shell 300a, about a virtual line (not illustrated) extending in the X-X′ direction substantially centrally of the first mountable portion 230a of the first terminal 200a. This arrangement facilitates controlling the impedance at the portion connecting the first mountable portion 230a of the first terminal 200a of the first connector part C1a to the circuit board.

### Second Embodiment

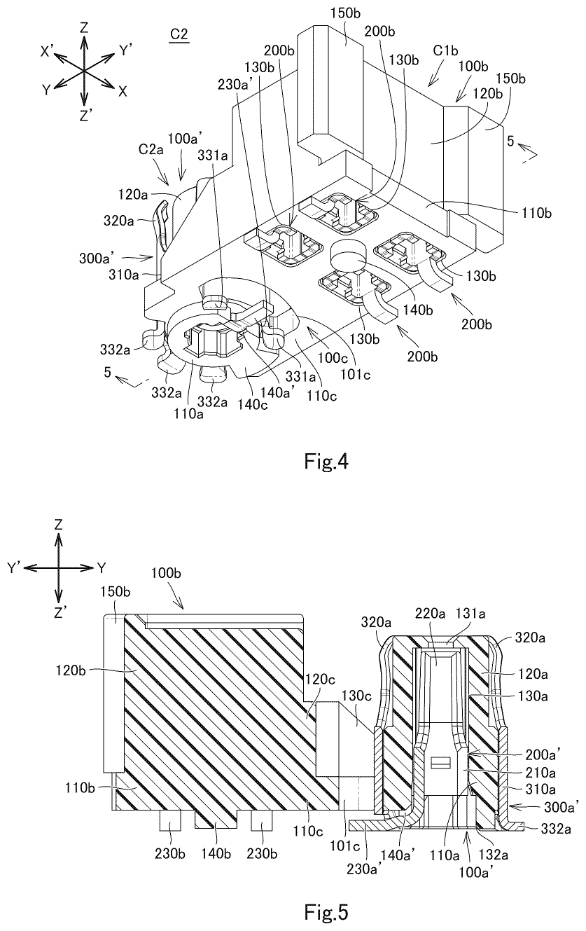

A hybrid connector C2 (not illustrated) (which may be referred to simply as “the connector C2”) according to a plurality of embodiments including the second embodiment of the invention and variants thereof will now be described with reference to FIGS. 4 and 5. FIGS. 4 and 5 illustrate the connector C2 of the second embodiment. The connector C2 is configured similarly to the connector C1, but different in that the connector C2 includes a first connector part C2a in place of the first connector part C1a. The following descriptions focus on the differences with overlapping descriptions omitted. Similarly to FIG. 1B, FIG. 4 shows the Z-Z′ direction, the Y-Y′ direction, and the X-X′ direction. Similarly to FIG. 2A, FIG. 5 shows the Z-Z′ direction and the Y-Y′ direction.

The first connector part C2a of the connector C2 includes a first body 100a′ and at least one first terminal 200a′.

Similarly to the first body 100a of the first connector part C1a of the connector C1 and the second body 100b of the second connector part C1b, the first body 100a′ of the first connector part C2a of the connector C2 and the second body 100b of the second connector part C1b are coupled by the coupling part 100c. The coupling part 100c may have any of configurations (1) to (6) described above, for example.

The first body 100a′ of the first connector part C2a has the same configuration as the first body 100a of the first connector part C1a, except that the first body 100a′ includes at least one first notch 140a′ of a different configuration from that of the at least one first notch 140a of the first body 100a of the first connector part C1a.

The at least one first notch 140a′ is a single first notch 140a or a plurality of first notches 140a′, corresponding to the number of the at least one first housing hole 130a. For convenience of description, the at least one first notch 140a′ will be described as a single first notch 140a′. However, also where a plurality of first notches 140a′ is provided, each of the first notches 140a′ may be configured similarly to the first notch 140a′ described below.

The first notch 140a′ extends through the lower portion 111a of the base 110a in the Y′ direction (see FIGS. 4 and 5), the first oblique direction (not illustrated), or the second oblique direction (not illustrated). The first notch 140a′ communicates with the first housing hole 130a. The first notch 140a‘ opens in the Z’ direction.

The first connector part C2a may further include a shell 300a′. The shell 300a′ includes a shell body 310a. The shell body 310a of the shell 300a′ has the same configuration as the shell body 310a of the shell 300a of the first connector part C1a of the connector C1, except for the following points.

Where the shell body 310a of the shell 300a′ of the first connector part C2a is provided with a third notch (not illustrated), the third notch extends through the shell body 310a in the same direction as the direction in which the first notch 140a extends, and communicates with the first notch 140a′. The third notch opens in the Z′ direction.

The shell 300a′ may further include a plurality of strips 320a. The plurality of strips 320a of the shell 300a′ has the same configuration as the plurality of strips 320a of the shell 300a of the first connector part C1a of the connector C1.

The shell 300a′ may or may not further include at least one third mountable portion 331a and/or at least one fourth mountable portion 332a. For convenience of description, the at least one third mountable portion 331a will be described as a plurality of third mountable portion 331a, the at least one fourth mountable portion 332a will be described as a plurality of fourth mountable portions 332a. However, also where a single third mountable portion 331a and a single fourth mountable portion 332a are provided, they may be respectively configured similarly to each of the third mountable portions 331a and each of the fourth mountable portions 332a described below.

The plurality of fourth mountable portions 332a of the shell 300a′ has the same configuration as the plurality of fourth mountable portions 332a of the shell 300a of the first connector part C1a of the connector C1.

The at least one first terminal 200a′ of the first connector part C2a may also be a single first terminal 200a′ or a plurality of first terminals 200a′. For convenience of description, the at least one first terminal 200a′ will be described as a single first terminal 200a′. However, also where a plurality of first terminals 200a′ are provided, each of the first terminal 200a′ may be configured similarly to the first terminal 200a′ described below.

The first terminal 200a′ of the first connector part C2a has the same configuration as the first terminal 200a of the first connector part C1a, except that the first terminal 200a′ includes a first mountable portion 230a′ having a different configuration from that of the first mountable portion 230a of the first terminal 200a of the first connector part C1a. The first mountable portion 230a′ may be a surface-mount type.

Where the shell body 310a of the shell 300a′ has configuration (a) or (b) described above, the first mountable portion 230a′ may be a generally L-shaped rod or plate, extend from the first retainable portion 210a of the first terminal 200a‘ in the Z’ direction, and then extend in the Y′ direction (see FIGS. 4 and 5), the first oblique direction (not illustrated), or the second oblique direction (not illustrated), or alternatively, the first mountable portion 230a′ may be a straight rod or plate, and extend from the first retainable portion 210a of the first terminal 200a′ in the Y′ direction, the first oblique direction, or the second oblique direction (not illustrated). The first mountable portion 230a′ extends through the first notch 140a′ of the first body 100a‘ and on the Z’-direction side relative to the shell body 310a, and a distal portion of the first mountable portion 230a′ is located, relative to the first body 100a′ and the shell body 310a, on the Y′-direction side (see FIGS. 4 and 5), the first-oblique-direction side (not illustrated), or the second-oblique-direction side (not illustrated).

Where the shell body 310a of the shell 300a′ has configuration (c) or (d) described above (not illustrated), the first mountable portion 230a′ is the generally L-shaped rod or plate described above or the straight rod or plate described above and extends through the first notch 140a′ of the first body 100a′ and the third notch of the shell body 310a, and the distal portion of the first mountable portion 230a′ is located on the Y′-direction side, the first-oblique-direction side, or the second-oblique-direction side relative to the first body 100a′ and the shell body 310a.

Where the face on the Z′-direction side of the coupling body 110c of the coupling part 100c is located on the Z′-direction side relative to the face on the Z′-direction side of the first body 100a′, the distal portion of the first mountable portion 230a′ is disposed on the Z′-direction side relative to the through hole 101c of the coupling part 100c (see FIGS. 4 to 5). Entireties, or parts on the Z′-direction side, of the plurality of third mountable portions 331a of the shell 300a′ are also disposed on the Z′-direction side relative to the through hole 101c of the coupling part 100c.

Where the face on the Z′-direction side of the coupling body 110c of the coupling part 100c is located at substantially the same height position in the Z-Z′ direction as the face on the Z′-direction side of the first body 100a′ (not illustrated), the distal portion of the first mountable portion 230a′ is disposed in the through hole 101c of the coupling part 100c. Entireties, or parts on the Z′-direction side, of the plurality of third mountable portions 331a of the shell 300a′ is also disposed in the through hole 101c of the coupling part 100c.

The distal portion of the first mountable portion 230a′ of the first terminal 200a′ and the entireties, or the parts on the Z′-direction side, of the plurality of third mountable portions 331a of the shell 300a′ are arranged such as not to coincide with each other, on the Z′-direction side relative to the through hole 101c of the coupling part 100c or in the through hole 101c of the coupling part 100c. For example, the distal portion of the first mountable portion 230a′ of the first terminal 200a′ and the plurality of third mountable portions 331a of the shell 300a′ may be arranged as follows.

The distal portion of the first mountable portion 230a′ of the first terminal 200a′ may extend in the Y′ direction (see FIGS. 4 and 5), while each of the third mountable portions 331a of the shell 300a′ may extend from the shell body 310a in the Z′ direction and then extend in the first oblique direction or the second oblique direction (see FIGS. 4 and 5), or alternatively may extend from the shell body 310a in the first oblique direction or the second oblique direction (not illustrated).

Alternatively, the distal portion of the first mountable portion 230a′ of the first terminal 200a′ may extend in the first oblique direction (not illustrated), while each of the third mountable portions 331a of the shell 300a′ may extend from the shell body 310a in the Z′ direction and then extend in the Y′ direction or the second oblique direction, or may extend from the shell body 310a in the Y′ direction or the second oblique direction.

Still alternatively, the distal portion of the first mountable portion 230a′ of the first terminal 200a′ may extend in the second oblique direction (not illustrated), while each of the third mountable portions 331a of the shell 300a′ may extend from the shell body 310a in the Z′ direction and then extend in the Y′ direction or the first oblique direction, or alternatively may extend from the shell body 310a in the Y′ direction or the first oblique direction.

The face on the Z′-direction side of the first mountable portion 230a′ of the first terminal 200a′, the faces on the Z′-direction side of the second mountable portions 230b of the plurality of second terminals 200b, the faces on the Z′-direction side of the plurality of third mountable portions 331a of the shell 300a′, and the faces on the Z′-direction side of the plurality of fourth mountable portions 332a (if provided) of the shell 300a′ are located at substantially the same height position in the Z-Z′ direction, and are located at substantially the same height position in the Z-Z′ direction as, or on the Z′-direction side relative to, the face on the Z′-direction side of the first body 100a.

The shell 300a′ can be omitted.

The connector C2 may be manufactured in a similar manner to the connector C1. The connector C2 may be surface-mounted on the circuit board in a similar manner to the connector C1. The first connector part C2a of the connector C2 may be connected to the third connector part of the mating connector in a similar manner to the first connector part C1a of the connector C1, and the second connector part C1b of the connector C2 may be connected to the fourth connector part of the mating connector in a similar manner to the second connector part C1b of the connector C1.

The connector C2 described above provides technical features and effects similar to technical features and effects (1) and (2) provided by the connector C1.

Moreover, the coupling part 100c is provided with the through hole 101c, and the distal portion of the first mountable portion 230a′ of the first terminal 200a′ is disposed on the Z′-direction side relative to the through hole 101c (see FIGS. 4 and 5) or alternatively disposed in the through hole 101c. It is therefore possible to check the mounting condition of the first mountable portion 230a′ of the first terminal 200a′ from the Z-direction side through the through hole 101c.

Furthermore, where the first connector part C2a of the connector C2 includes the shell 300a′, the connector C2 provides technical features and effects similar to technical features and effects (3) to (5) provided by the connector C1.

Further, where the plurality of third mountable portions 331a of the shell 300a′ of the first connector part C2a are provided, and the first mountable portion 230a′ of the first terminal 200a′ of the first connector part C2a extends from the first retainable portion 210a in the Z′ direction and then extends in the Y′ direction, or alternatively extends from the first retainable portion 210a in the Y′ direction, the plurality of third mountable portions 331a of the shell 300a′ includes one or a plurality of third mountable portions 331a located on the X-direction side relative to the first mountable portion 230a′ of the first terminal 200a′ and another one or a plurality of third mountable portions 331a located on the X′-direction side relative to the first mountable portion 230a′ of the first terminal 200a′. The one or plurality of third mountable portions 331a on the X-direction side may be arranged symmetrically in the X-X′ direction to the one or plurality of third mountable portions 331a on the X′-direction side about a virtual line (not illustrated) extending in the Y-Y′ direction substantially centrally of the first mountable portion 230a of the first terminal 200a. In this case, it is easy to control the impedance at the portion connecting the first mountable portion 230a′ of the first terminal 200a′ of the first connector part C2a to the circuit board.

### Third Embodiment

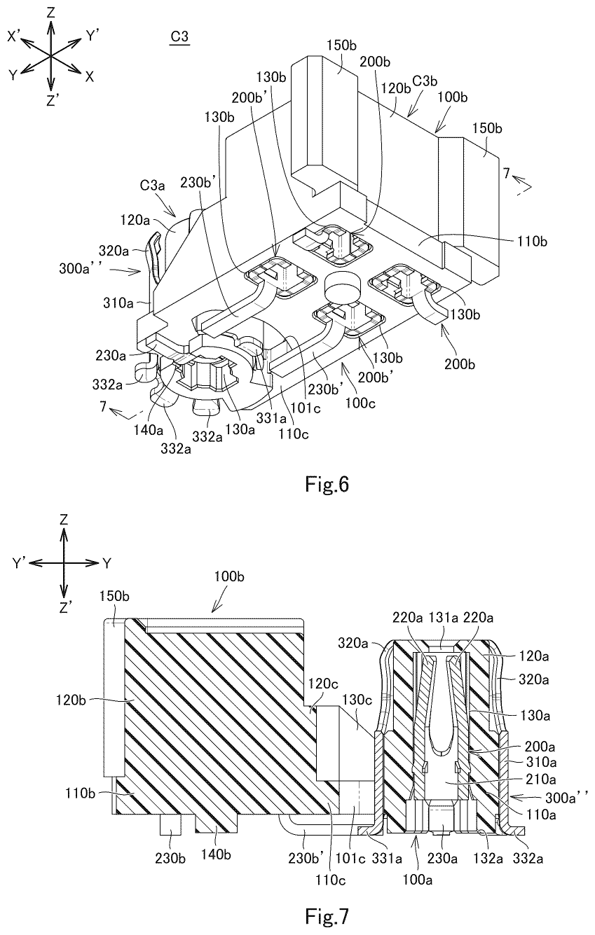

A hybrid connector C3 (not illustrated) (which may be referred to simply as “the connector C3”) according to a plurality of embodiments including the third embodiment of the invention and variants thereof will now be described with reference to FIGS. 6 and 7. FIGS. 6 and 7 illustrate the connector C3 of the third embodiment. The connector C3 is configured similarly to the connector C1, but different in that the connector C3 includes a first connector part C3a, in place of the first connector part C1a, and includes a second connector part C3b, in place of the second connector part C1b. The following descriptions focus on the differences with overlapping descriptions omitted. Similarly to FIG. 1B, FIG. 6 shows the Z-Z′ direction, the Y-Y′ direction, and the X-X′ direction. Similarly to FIG. 2A, FIG. 7 shows the Z-Z′ direction and the Y-Y′ direction.

The first connector part C3a of the connector C3 includes a first body 100a and at least one first terminal 200a.

The first body 100a of the first connector part C3a of the connector C3 has the same configuration as the first body 100a of the first connector part C1a of the connector C1.

The at least one first terminal 200a of the first connector part C3a of the connector C3 has the same configuration as the at least one first terminal 200a of the first connector part C1a of the connector C1. For convenience of description, the at least one first terminal 200a will be described as a single first terminal 200a. However, also where a plurality of first terminals 200a is provided, each of the first terminal 200a may be configured similarly to the first terminal 200a described below.

The first connector part C3a of the connector C3 may further include a shell 300a″. The shell 300a″ includes a shell body 310a. The shell body 310a of the shell 300a″ has the same configuration as the shell body 310a of the shell 300a of the first connector part C1a of the connector C1.

The shell 300a″ may or may not further include a plurality of strips 320a. The plurality of strips 320a of the shell 300a″ has the same configuration as the plurality of strips 320a of the shell 300a of the first connector part C1a of the connector C1.

The shell 300a″ may or may not further include at least one third mountable portion 331a and/or at least one fourth mountable portion 332a.

The at least one third mountable portion 331a of the shell 300a″ has the same configuration as the at least one third mountable portion 331a of the shell 300a of the first connector part C1a of the connector C1.

The at least one fourth mountable portion 332a of the shell 300a″ has the same configuration as the at least one fourth mountable portion 332a of the shell 300a of the first connector part C1a of the connector C1.

The second connector part C3b of the connector C3 includes a second body 100b. The second body 100b of the second connector part C3b of the connector C3 has the same configuration as the second body 100b of the second connector part C1b of the connector C1. Similarly to the first body 100a of the first connector part C1a of the connector C1 and the second body 100b of the second connector part C1b, the first body 100a of the first connector part C3a of the connector C3 and the second body 100b of the second connector part C3b are coupled by the coupling part 100c. The coupling part 100c may have any of the configurations (1) to (6) described above, for example.

The second connector part C3b of the connector C3 further includes at least one second terminal 200b′. The at least one second terminal 200b′ of the second connector part C3b may be a single second terminal 200b′ or a plurality of second terminals 200b′. For convenience of description, the at least one second terminal 200b′ will be described as a plurality of second terminals 200b′. However, also where a single second terminal 200b′ is provided, it may be configured similarly to each of the second terminals 200b′ described below.

Each of the second terminals 200b′ has the same configuration as the at least one second terminal 200b of the second connector part C1b of the connector C1, except that each second terminals 200b′ includes a second mountable portion 230b′ of a different configuration from that of the second mountable portion 230b of the at least one second terminal 200b of the second connector part C1b of the connector C1.

The second mountable portion 230b′ of each second terminal 200b′ may be a surface-mount type.

Where the face on the Z′-direction side of the second body 100b and the face on the Z′-direction side of the coupling part 100c are located on the Z-direction side relative to the face on the Z′-direction side of the first body 100a (see FIGS. 6 and 7), the second mountable portion 230b′ of each second terminal 200b′ is a generally L-shaped rod or plate, extends from the second retainable portion 210b of each second terminal 200b‘ in the Z’ direction, and then extends in the Y direction (see FIGS. 6 and 7), the third oblique direction (not illustrated), or the fourth oblique direction (not illustrated). The distal portion of the second mountable portion 230b′ of each of the second terminals 200b′ is disposed on the Z′-direction side relative to the through hole 101c of the coupling body 110c of the coupling part 100c. The entirety, or a part on the Z′-direction side, of the at least one third mountable portion 331a of the shell 300a″ is also disposed on the Z′-direction side relative to the through hole 101c of the coupling part 100c.

Where the face on the Z′-direction side of the second body 100b and the face on the Z′-direction side of the coupling part 100c are located at substantially the same height position as the face on the Z′-direction side of the first body 100a (not illustrated), the second mountable portion 230b′ of each second terminal 200b′ is a generally L-shaped rod or plate, extends from the second retainable portion 210b of each second terminal 200b‘ in the Z’ direction, then extends in the Y direction, the third oblique direction, or the fourth oblique direction, and extends through the lower portion 110b of the second body 100b. The distal portion of the second mountable portion 230b′ of each second terminal 200b′ is disposed in the through hole 101c of the coupling body 110c of the coupling part 100c. The entirety, or the part on the Z′-direction side, of the at least one third mountable portion 331a of the shell 300a″ is also disposed in the through hole 101c of the coupling part 100c.

The distal portions of the second mountable portions 230b′ of the plurality of second terminals 200b′ and the entirety, or the part on the Z′-direction side, of the at least one third mountable portion 331a of the shell 300a″ are arranged such as not to coincide with each other, on the Z′-direction side relative to the through hole 101c of the coupling part 100c or in the through hole 101c of the coupling part 100c. For example, among the plurality of second terminal 200b′ (all second terminals 200b′), the distal portion of the second mountable portion 230b′ of at least one second terminal 200b′ may be disposed on the X-direction side relative to the at least one third mountable portion 331a of the shell 300a″, on the Z′-direction side relative to the through hole 101c or in the through hole 101c, and the distal portion of the second mountable portion 230b′ of the remaining at least one second terminal 200b′ may be disposed on the X′-direction side relative to the at least one third mountable portion 331a of the shell 300a″, on the Z′-direction side relative to the through hole 101c or in the through hole 101c. Alternatively, the distal portions of the second mountable portions 230b′ of the plurality of second terminals 200b′ (all second terminal 200b′) may be disposed on the X- or X′-direction side relative to the at least one third mountable portion 331a of the shell 300a″, on the Z′-direction side relative to the through hole 101c or in the through hole 101c.

The second connector part C3b may further include at least one second terminal 200b. The at least one second terminal 200b of the second connector part C3b may have the same configuration as the at least one second terminal 200b of the second connector part C1b of the connector C1.

The face on the Z′-direction side of the first mountable portion 230a of the first terminal 200a, the faces on the Z′-direction side of the second mountable portions 230b′ of the plurality of second terminals 200b′, the face on the Z′-direction side of the second mountable portion 230b of the at least one second terminal 200b, the face on the Z′-direction side of the at least one third mountable portion 331a (if provided) of the shell 300a″, and the face on the Z′-direction side of the fourth mountable portion 332a (if provided) of the shell 300a″ are located at substantially the same height position in the Z-Z′ direction, and are located at substantially the same height position in the Z-Z′ direction as, or on the Z′-direction side relative to, the face on the Z′-direction side of the first body 100a.

The shell 300a″ and/or the at least one second terminal 200b can be omitted.

The connector C3 described above provides technical features and effects similar to technical features and effects (1), (2), and (6) provided by the connector C1.

Moreover, the coupling part 100c is provided with the through hole 101c, and the distal portions of the second mountable portions 230b′ of the plurality of second terminals 200b′ are disposed on the Z′-direction side relative to the through hole 101c (see FIGS. 6 and 7) or alternatively disposed in the through hole 101c. It is therefore possible to check the mounting condition of the second mountable portions 230b′ of the plurality of second terminals 200b′ from the Z-direction side through the through hole 101c.

Furthermore, where the first connector part C3a of the connector C3 includes the shell 300a″, the connector C3 provides technical features and effects similar to technical features and effects (3) to (5) provided by the connector C1.

Furthermore, where the first connector part C3a of the connector C3 includes the plurality of third mountable portions 331a and the plurality of fourth mountable portions 332a of the shell 300a″, and the first mountable portion 230a of the first terminal 200a of the first connector part C3a extends from the first retainable portion 210a in the Z′ direction and then extends in the X or X′ direction, or alternatively extends from the first retainable portion 210a in the X or X′ direction, the connector C3 has provides technical features and effects similar to technical feature and effect (7) provided by the connector C1.

The hybrid connectors described above are not limited to the embodiments described above, but may be modified as appropriate within the scope of the claims. Some examples of modification will now be described.

The first mountable portion 230a of the or each first terminal 200a of the first connector part C1a or C3a may be a generally L-shaped rod or plate configured as described above, extend on the Z′-direction side relative to the first body 100a and the shell body 310a, and include a distal portion located on the Y-direction side, the X-direction side, the X′-direction side, the third-oblique-direction side, or the fourth-oblique-direction side relative to the first body 100a and the shell body 310a. In this case, the first notch 140a of the first body 100a of the first connector part C1a or C3a is omitted. Where the shell body 310a of the shell 300a of the first connector part C1a or the shell body 310a of the shell 300a″ of the first connector part C3a has configuration (c) or (d) described above, the third notch of the shell body 310a is also omitted.

The first mountable portion 230a′ of the or each first terminal 200a′ of the first connector part C2a may be a generally L-shaped rod or plate configured as described above, extend on the Z′-direction side relative to the first body 100a and the shell body 310a, and include a distal portion located on the Y′-direction side relative to the first body 100a and the shell body 310a and located on the Z′-direction side relative to the through hole 101c of the coupling part 100c. In this case, the first notch 140a′ of the first body 100a′ of the first connector part C2a is omitted. Where the shell body 310a of the shell 300a′ of the first connector part C2a has configuration (c) or (d) described above, the third notch of the shell body 310a is also omitted.

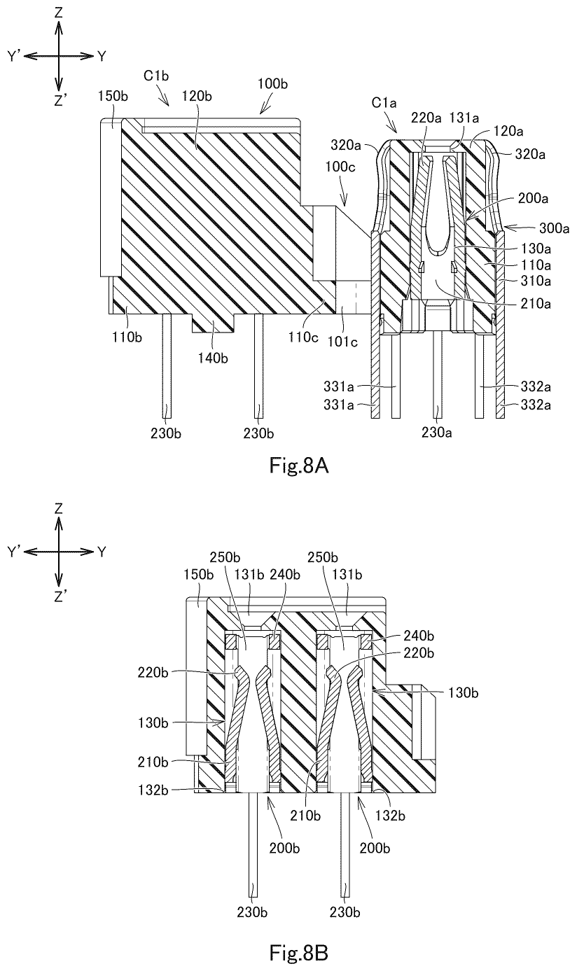

The connector C1 described above may be modified such that the first mountable portion 230a of the or each first terminal 200a of the first connector part C1a, the second mountable portion 230b of the or each second terminal 200b of the second connector part C1b, and the or each third mountable portion 331a of the shell 300a of the first connector part C1a are each a through-hole type as described below (see FIG. 8A). Where the shell 300a of the first connector part C1a of the connector C1 includes the at least one fourth mountable portion 332a, the or each fourth mountable portion 332a may also be a through-hole type as described below (see FIGS. 8A and 8B). In other respects, this modified connector C1 is configured similarly to the connector C1 described above.

The first mountable portion 230a of the or each first terminal 200a is a rod extending from the first retainable portion 210a in the Z′ direction. The entirety, or a part on the Z′-direction side, of the first mountable portion 230a of the or each first terminal 200a protrudes from the or a corresponding first housing hole 130a of the first body 100a of the first body 100a of the first connector part C1a and is located on the Z′-direction side relative to the first body 100a.

The second mountable portion 230b of the or each second terminal 200b is a rod extending from the second retainable portion 210b in the Z′ direction. The entirety, or a part on the Z′-direction side, of the second mountable portion 230b of the or each second terminal 200b protrudes from the or a corresponding second housing hole 130b of the second body 100b of the second connector part C1b and is located on the Z′-direction side relative to the second body 100b.

The or each third mountable portion 331a is a rod extending from the shell body 310a in the Z′ direction. The entirety, or a part on the Z′-direction side, of the or each third mountable portion 331a is located on the Z′-direction side relative to the first body 100a and the shell body 310a and located on the Z′-direction side relative to the through hole 101c of the coupling part 100c.

The or each fourth mountable portion 332a is a rod extending from the shell body 310a in the Z′ direction. The entirety, or a part on the Z′-direction side, of the or each fourth mountable portion 332a is located on the Z′-direction side relative to the first body 100a and the shell body 310a.

The first mountable portion 230a of the or each first terminal 200a is configured to be received in a corresponding first through-hole electrode of a circuit board (not illustrated) and connected thereto by a soldering method (e.g., reflow soldering) or other known connection method. The second mountable portion 230b of the or each second terminal 200b is configured to be received in a corresponding second through-hole electrode of the circuit board and connected thereto by a soldering method (e.g., reflow soldering) or other known connection method. The or each third mountable portion 331a is configured to be received in a corresponding third through-hole electrode of the circuit board and connected thereto by a soldering method (e.g., reflow soldering) or other known connection method. It is possible to check the mounting condition of the or each third mountable portion 331a from the Z-direction side through the through hole 101c. The or each fourth mountable portion 332a (if provided) is configured to be received in a corresponding fourth through-hole electrode of the circuit board and connected thereto by a soldering method (e.g., reflow soldering) or other known connection method.

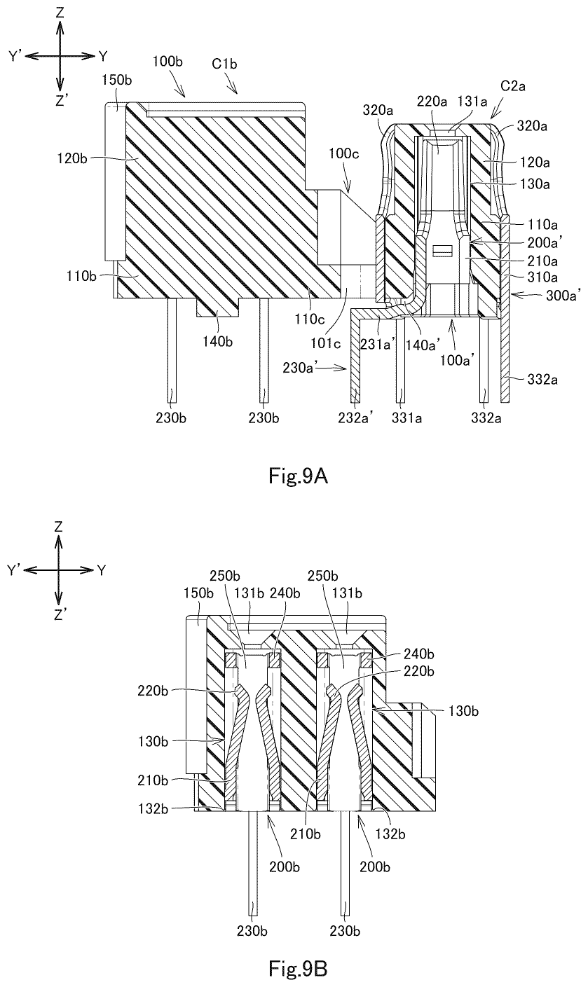

The connector C2 described above may be modified such that the first mountable portion 230a′ of the or each first terminal 200a′ of the first connector part C2a and the second mountable portion 230b of the or each second terminal 200b of the second connector part C1b are each a through-hole type as described below (see FIGS. 9A and 9B). Where the shell 300a′ of the first connector part C2a of the connector C2 includes the at least one third mountable portion 331a and/or the at least one fourth mountable portion 332a, the or each third mountable portion 331a and/or the or each fourth mountable portion 332a may also each be a through-hole type as described below (see FIGS. 9A and 9B). In other respects, this modified connector C2 is configured similarly to the connector C2 described above.

The first mountable portion 230a′ of the or each first terminal 200a′ is a bent rod and includes a first portion 231a′ and a second portion 232a′. The first portion 231a′ of the first mountable portion 230a′ of each first terminal 200a′ may extend from the first retainable portion 210a of each first terminal 200a‘ in the Z’ direction, and then extends in the Y′ direction, the first oblique direction, or the second oblique direction. Alternatively, the first portion 231a′ of the first mountable portion 230a′ of each first terminal 200a′ may extend from the first retainable portion 210a of each first terminal 200a′ in the Y′ direction, the first oblique direction, or the second oblique direction. The second portion 232a′ of the first mountable portion 230a′ of each first terminal 200a′ extends in the Z′ direction from a distal end of the first portion 231a′ of the first mountable portion 230a′ of each first terminal 200a′ and is located on the Z′-direction side relative to the through hole 101c of the coupling part 100c.

The second mountable portion 230b of the or each second terminal 200b is a rod extending from the second retainable portion 210b in the Z′ direction. The entirety, or a part on the Z′-direction side, of the or each second mountable portion 230b protrudes from the or a corresponding second housing hole 130b of the second body 100b of the second connector part C1b and is located on the Z′-direction side relative to the second body 100b.

The or each third mountable portion 331a of the shell 300a′ is a rod extending from the shell body 310a in the Z′ direction. The entirety, or a part on the Z′-direction side, of the or each third mountable portion 331a is located on the Z′-direction side relative to the first body 100a and the shell body 310a and located on the Z′-direction side relative to the through hole 101c of the coupling part 100c.

The or each fourth mountable portion 332a of the shell 300a′ is a rod extending from the shell body 310a in the Z′ direction. The entirety, or a part on the Z′-direction side, of the or each fourth mountable portion 332a is located on the Z′-direction side relative to the first body 100a and the shell body 310a.

The second portion 232a′ of the first mountable portion 230a′ of the or each first terminal 200a′ is configured to be received in a corresponding first through-hole electrode of a circuit board (not illustrated) and connected thereto by a soldering method (e.g. reflow soldering) or other known connection method. It is possible to check the mounting condition of the first mountable portion 230a′ of the or each first terminal 200a′ from the Z-direction side through the through hole 101c. The second mountable portion 230b of the or each second terminal 200b is configured to be received in a corresponding second through-hole electrode of the circuit board and connected thereto by a soldering method (e.g., reflow soldering) or other known connection method. The or each third mountable portion 331a (if provided) is configured to be received in a corresponding third through-hole electrode of the circuit board and connected thereto by a soldering method (e.g., reflow soldering) or other known connection method. It is possible to check the mounting condition of the or each third mountable portion 331a from the Z-direction side through the through hole 101c. The or each fourth mountable portion 332a (if provided) is configured to be received in a corresponding fourth through-hole electrode of the circuit board and connected thereto by a soldering method (e.g., reflow soldering) or other known connection method.

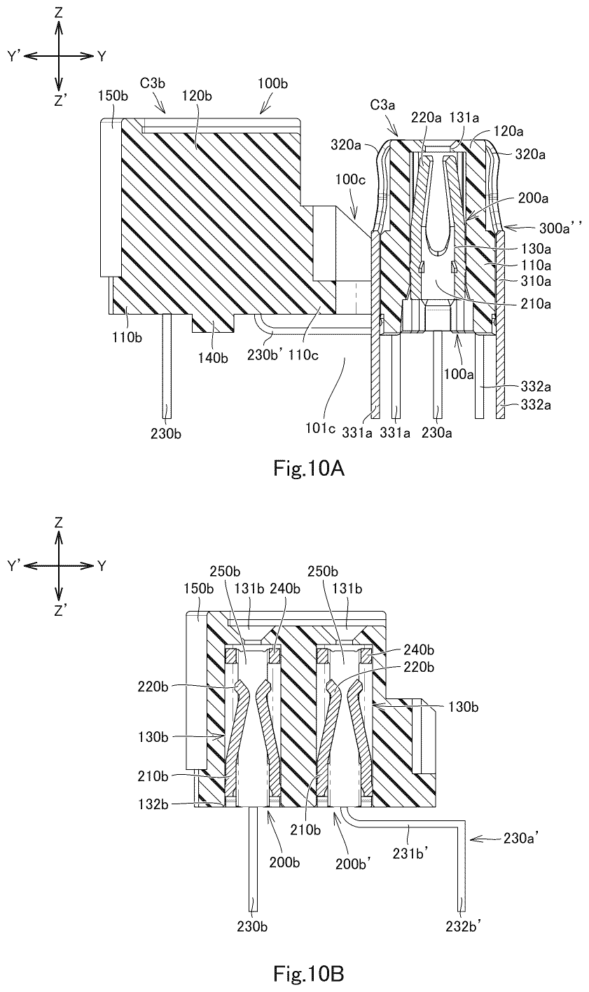

The connector C3 described above may be modified such that the first mountable portion 230a of the or each first terminal 200a of the first connector part C3a and the second mountable portion 230b′ of the or each second terminal 200b′ of the second connector part C3b are each a through-hole type as described below (see FIGS. 10A and 10B). Where the second connector part C3b includes the at least one second terminal 200b, the second mountable portion 230b of the or each second terminal 200b may also be a through-hole type as described below (see FIGS. 10A and 10B). Where the shell 300a″ of the first connector part C3a of the connector C3 includes the at least one third mountable portion 331a and/or the at least one fourth mountable portion 332a, the or each third mountable portion 331a and/or the or each fourth mountable portion 332a may also each be a through-hole type as described below (see FIGS. 10A and 10B). In other respects, this modified connector C3 is configured similarly to the connector C3 described above.

The first mountable portion 230a of the or each first terminal 200a is a rod extending from the first retainable portion 210a in the Z′ direction. The entirety, or a part on the Z′-direction side of the first mountable portion 230a of the or each first terminal 200a protrudes from the or a corresponding first housing hole 130a of the first body 100a of the first body 100a of the first connector part C3a and is located on the Z′-direction side relative to the first body 100a.

The second mountable portion 230b′ of the or each second terminal 200b′ may be a bent rod and may include a first portion 231b′ and a second portion 232b′. The first portion 231b′ of the second mountable portion 230b′ of the or each second terminal 200b′ may extend from the second retainable portion 210b of the or each second terminal 200b‘ in the Z’ direction, and then extend in the Y direction, the third oblique direction, or the fourth oblique direction. Alternatively, the first portion 231b′ of the second mountable portion 230b′ of the or each second terminal 200b′ may extend from the second retainable portion 210b of each second terminal 200b′ in the Y direction, the third oblique direction, or the fourth oblique direction. The second portion 232b′ of the second mountable portion 230b′ of the or each second terminal 200b′ extends in the Z′ direction from a distal end of the first portion 231b′ of the second mountable portion 230b′ of the or each second terminal 200b′ and is located on the Z′-direction side relative to the through hole 101c of the coupling part 100c.

The second mountable portion 230b of the or each second terminal 200b is a rod extending from the second retainable portion 210b of the or each second terminal 200b‘ in the Z’ direction. The entirety, or a part on the Z′-direction side, of the second mountable portion 230b of the or each second terminal 200b′ protrudes from the or a corresponding second housing hole 130b of the second body 100b of the second connector part C1b and is located on the Z′-direction side relative to the second body 100b.

The or each third mountable portion 331a of the shell 300a″ is a rod extending from the shell body 310a in the Z′ direction. The entirety, or a part on the Z′-direction side, of the or each third mountable portion 331a is located on the Z′-direction side relative to the first body 100a and the shell body 310a and located on the Z′-direction side relative to the through hole 101c of the coupling part 100c.

The or each fourth mountable portion 332a of the shell 300a″ is a rod extending from the shell body 310a in the Z′ direction. The entirety, or a part on the Z′-direction side, of the or each fourth mountable portion 332a is located on the Z′-direction side relative to the first body 100a and the shell body 310a.

The first mountable portion 230a of the or each first terminal 200a is configured to be received in a corresponding first through-hole electrode of a circuit board (not illustrated) and connected thereto by a soldering method (e.g., reflow soldering) or other known connection method. The second portion 232b′ of the second mountable portion 230b′ of the or each second terminal 200b′ is configured to be received in a corresponding second through-hole electrode of the circuit board and connected thereto by a soldering method (e.g., reflow soldering) or other known connection method. It is possible to check the mounting condition of the second mountable portion 230b′ of the or each second terminal 200b′ from the Z-direction side through the through hole 101c. The second mountable portion 230b of the or each second terminal 200b (if provided) is configured to be received in a corresponding another second through-hole electrode of the circuit board and connected thereto by a soldering method (e.g., reflow soldering) or other known connection method. The or each third mountable portion 331a (if provided) is configured to be received in a corresponding third through-hole electrode of the circuit board and connected thereto by a soldering method (e.g., reflow soldering) or other known connection method. It is possible to check the mounting condition of the at least one third mountable portion 331a from the Z-direction side through the through hole 101c. The or each fourth mountable portion 332a (if provided) is configured to be received in a corresponding fourth through-hole electrode of the circuit board and connected thereto by a soldering method (e.g., reflow soldering) or other known connection method.

The first contacting portion 220a of the or each first terminal 200a may extend in the Z direction from the first retainable portion 210a of each first terminal 200a and may be exposed, or protrude, at least partly from the first body 100a. For example, the first contacting portion 220a of the or each first terminal 200a may protrude from the first body 100a in the Z direction. The first contacting portion 220a of the or each first terminal 200a′ may extend in the Z direction from the first retainable portion 210a of each first terminal 200a′ and may be exposed, or protrude, at least partly from the first body 100a′. For example, the first contacting portion 220a of the or each first terminal 200a′ may protrude from the first body 100a′ in the Z direction.

The second contacting portions 220b of the or each second terminals 200b or 200b′ may extend in the Z direction from the second retainable portion 210b of each second terminals 200b or 200b′ and may be exposed, or protrude, at least partly from the second body 100b. For example, the second contacting portions 220b of the or each second terminals 200b and 200b′ may protrude from the second body 100b in the Z direction.

The first retainable portion 210a of the or each first terminal 200a is only required to be retained in the first body 100a. For example, the first retainable portion 210a of the or each first terminal 200a may be insert-molded in the first body 100a. The second retainable portion 210b of the or each second terminals 200b or 200b′ is only required to be retained in the second body 100b. For example, the second retainable portions 210b of the or each second terminals 200b or 200b′ may be insert-molded in the second body 100b. Also where the second retainable portions 210b of the plurality of second terminals 200b or 200b′ are insert-molded in the second body 100b, the second retainable portions 210b are arranged in the second body 100b, in spaced relation to each other in the X-X′ direction and/or the Y-Y′ direction.

The at least one through hole 101c of the coupling part 100c of the connector C1 may be a plurality of through holes, corresponding to the number of the plurality of third mountable portions 331a of the shell 300a of the first connector part C1a of the connector C1. In this case, the plurality of through holes 101c may correspond to the plurality of third mountable portions 331a on a one-to-one basis. The entirety, or a part on the Z′-direction side, of each surface-mount-type third mountable portion 331a of the shell 300a may be disposed on the Z′-direction side relative to, or alternatively disposed in, a corresponding one of the through holes 101c. Alternatively, The entirety, or a part on the Z′-direction side, of each through-hole-type third mountable portion 331a of the shell 300a may be disposed on the Z′-direction side relative to a corresponding one of the through holes 101c.

Where the at least one third mountable portion 331a of the shell 300a′ of the first connector part C2a of the connector C2 is not provided, the at least one through hole 101c of the coupling part 100c of the connector C2 may be a plurality of through holes, corresponding to the number of the plurality of first terminals 200a′ of the first connector part C2a. In this case, the plurality of through holes 101c may correspond to the plurality of first terminals 200a′ on a one-to-one basis. The distal portion of the surface-mount type first mountable portion 230a′ of each first terminal 200a′ may be disposed on the Z′-direction side relative to, or alternatively disposed in, a corresponding one of the through holes 101c. Alternatively, the second portion 232a′ of the through-hole type first mountable portion 230a′ of each first terminal 200a′ may be disposed on the Z′-direction side relative to a corresponding one of the through holes 101c.

Where the at least one third mountable portion 331a of the shell 300a′ of the first connector part C2a of the connector C2 is provided, the at least one through hole 101c of the coupling part 100c of the connector C2 may be a plurality of through holes, corresponding to the total number of the at least one first terminals 200a′ of the first connector part C2a and the at least one third mountable portions 331a of the shell 300a′. In this case, the plurality of through holes 101c include at least one first through hole 101c corresponding to the at least one first terminal 200a′ and at least one second through hole 101c corresponding to the at least one third mountable portion 331a of the shell 300a′. The distal portion of the surface-mount type first mountable portion 230a′ of the or each first terminal 200a′ may be disposed on the Z′-direction side relative to, or alternatively disposed in, the or a corresponding first through hole 101c, and the entirety, or a part on the Z′-direction side, of the or each surface-mount-type third mountable portion 331a of the shell 300a′ may be disposed on the Z′-direction side relative to, or alternatively disposed in, the or a corresponding second through hole 101c. Alternatively, the second portion 232a′ of the through-hole type first mountable portion 230a′ of the or each first terminal 200a′ may be disposed on the Z′-direction side relative to the or a corresponding first through hole 101c, and the entirety, or the part on the Z′-direction side, of the or each the at least one through-hole-mount-type third mountable portion 331a of the shell 300a′ may be disposed on the Z′-direction side relative to the or a corresponding second through hole 101c.

Where the at least one third mountable portion 331a of the shell 300a″ of the first connector part C3a of the connector C3 is not provided, the at least one through hole 101c of the coupling part 100c of the connector C3 may be a plurality of through holes, corresponding to the number of the plurality of second terminals 200b′ of the second connector part C3b. In this case, the plurality of through holes 101c may correspond to the plurality of second terminals 200b′ on a one-to-one basis. The distal portion of the surface-mount type second mountable portion 230b′ of each second terminal 200b′ may be disposed on the Z′-direction side relative to, or alternatively disposed in, a corresponding one of the through holes 101c. Alternatively, the second portion 232b′ of the through-hole type second mountable portion 230b′ of each second terminal 200b′ may be disposed on the Z′-direction side relative to a corresponding one of the through holes 101c.

Where the at least one third mountable portion 331a of the shell 300a″ of the first connector part C3a of the connector C3 is provided, the at least one through hole 101c of the coupling part 100c of the connector C3 may be a plurality of through holes, corresponding to the total number of the at least one second terminals 200b′ of the first connector part C3a and the at least one third mountable portions 331a of the shell 300a″. In this case, the plurality of through holes 101c include at least one first through hole 101c corresponding to the at least one second terminal 200b′ and at least one second through hole 101c corresponding to the at least one third mountable portion 331a of the shell 300a″. The distal portion of the surface-mount type second mountable portion 230b′ of the or each second terminal 200b′ may be disposed on the Z′-direction side relative to, or alternatively disposed in, the or a corresponding first through hole 101c, and the entirety, or a part on the Z′-direction side, of the or each surface-mount-type third mountable portion 331a of the shell 300a″ may be disposed on the Z′-direction side relative to, or alternatively disposed in, the or a corresponding second through hole 101c. Alternatively, the second portion 232b′ of the through-hole type second mountable portion 230b′ of the or each second terminal 200b′ may be disposed on the Z′-direction side relative to the or a corresponding first through hole 101c, and the entirety, or a part on the Z′-direction side, of the or each through-hole-mount-type third mountable portion 331a of the shell 300a″ may be disposed on the Z′-direction side relative to the or a corresponding second through hole 101c.

The second connector part C1b of the connector C1 or the connector C2, or the second connector part C3b of the connector C3 may further include a shell (not illustrated). The shell of the second connector part C1b or C3b is only required to have electrical conductivity and cover at least a part of the second body 100b.

The third connector part and the fourth connector part may be included in the mating connector as described above but may be separate mating connectors. The third connector part may be connectable to the first connector part C1a of the connector C1, the first connector part C2a of the connector C2, or the first connector part C3a of the connector C3. The fourth connector part may be connectable to the second connector part C1b of the connector C1, the second connector part C1b of the connector C2, or the second connector part C3b of the connector C3.

### REFERENCE SIGNS LIST

C1, C2, C3: hybrid connector
C1a, C2a, C3a: first connector part
100a, 100a′: first body
110a: base; 111a: lower portion; 112a: upper portion
120a: distal portion
130a: first housing hole
140a, 140a′: first notch
200a, 200a′: first terminal
210a: first retainable portion; 220a: first contacting portion; 230a, 230a′: first mountable portion
300a, 300a′, 300a″: shell
310a: shell body; 320a: strip; 331a: third mountable portion; 332a: fourth mountable portion
C1b, C3b: second connector part
100b: second body
110b: lower portion
120b: upper portion
130b: second housing hole
140b: protrusion
100c: coupling part
101c: through hole
110c: coupling body
111c: first portion; 112c: second portion; 113c: third portion; 114c: fourth portion; 115c: fifth portion
120c: projecting portion
130c: reinforcing portion
140c: protrusion
200b, 200b′: second terminal
210b: second retainable portion; 220b: second contacting portion; 230b, 230b′: second mountable portion

What is claimed is:

1. A hybrid connector comprising:
a first connector part;
a second connector part; and
a coupling part, wherein
the first connector part includes
a first body being constituted by an insulating material and extending in a first direction,
at least one first terminal constituted by an electrically conductive material, and
a shell having electrical conductivity,
the at least one first terminal includes
a first retainable portion retained in the first body,
a first contacting portion extending from the first retainable portion to one side in the first direction, the first contacting portion being exposed, or protruding, at least partly from the first body, and
a first mountable portion at least partly located on the other side in the first direction, one side in a second direction, one side in a third direction, or the other side in the third direction relative to the first body, wherein the first direction is a height direction of the first body, the second direction is substantially orthogonal to the first direction, and the third direction is substantially orthogonal to the first direction and crosses the second direction,
the shell includes a shell body covering at least a part of an outer face of the first body, and at least one third mountable portion,
the second connector part includes
a second body being constituted by an insulating material, extending in the first direction, and being disposed in spaced relation to, and on the other side in the second direction relative to, the first body, and
at least one second terminal constituted by an electrically conductive material,
the at least one second terminal includes
a second retainable portion retained in the second body,
a second contacting portion extending from the second retainable portion to the one side in the first direction, the second contacting portion being exposed, or protruding, at least partly from the second body, and
a second mountable portion at least partly located on the other side in the first direction, the other side in the second direction, the one side in the third direction, or the other side in the third direction relative to the second body, and
the coupling part couples the first body and the second body and includes at least one through hole extending through the coupling part in the first direction, and the at least one third mountable portion of the shell is at least partly disposed on the other side in the first direction relative to, or at least partly disposed in, the at least one through hole.

2. The hybrid connector according to claim 1, wherein
the first mountable portion of the at least one first terminal extends at least partly to the one side in the second direction and is located at least partly on the one side in the second direction relative to the first body, extends at least partly to the one side in the third direction and is located at least partly on the one side in the third direction relative to the first body, or extends at least partly on the other side in the third direction and is located at least partly on the other side in the third direction relative to the first body,
the second mountable portion of the at least one second terminal extends at least partly to the other side in the second direction and is located at least partly on the other side in the second direction relative to the second body, extends at least partly to the one side in the third direction and is located at least partly on the one side in the third direction relative to the second body, or extends at least partly to the other side in the third direction and is located at least partly on the other side in the third direction relative to the second body,
the at least one third mountable portion of the shell extends at least partly to the other side in the second direction, the one side in the third direction, or the other side in the third direction, and
a face on the other side in the first direction of the first mountable portion, a face on the other side in the first direction of the second mountable portion, and a face on the other side in the first direction of the at least one third mountable portion are located at a substantially the same height position in the first direction.

3. The hybrid connector according to claim 2, wherein
a face on the other side in the first direction of the coupling part is located on the one side in the first direction relative to a face on the other side in the first direction of the first body, and
the at least one third mountable portion of the shell is at least partly disposed on the other side in the first direction relative to the at least one through hole.

4. The hybrid connector according to claim 1, wherein
the first mountable portion of the at least one first terminal extends at least partly to the other side in the first direction and is located at least partly on the other side in the first direction relative to the first body,
the second mountable portion of the at least one second terminal extends at least partly to the other side in the first direction and is located at least partly on the other side in the first direction relative to the second body, and
the at least one third mountable portion of the shell extends at least partly to the other side in the first direction, is located at least partly on the other side in the first direction relative to the coupling part, and is disposed at least partly on the other side in the first direction relative to the at least one through hole.

5. The hybrid connector according to claim 1, wherein
the shell body of the shell is shaped like a tube extending in the first direction and covers at least a part of an outer peripheral face of the first body, and
the at least one first terminal is a single first terminal, and the first retainable portion and/or the first contacting portion is arranged substantially coaxially with the first body and the shell body.

6. The hybrid connector according to claim 1, wherein the shell body of the shell is shaped like a tube extending in the first direction, fits over the first body from the one side in the first direction, and abuts a boundary portion between the first body and the coupling part from the one side in the first direction.

7. A hybrid connector comprising:
a first connector part;
a second connector part; and
a coupling part, wherein
the first connector part includes
a first body being constituted by an insulating material and extending in a first direction, and
at least one first terminal constituted by an electrically conductive material,
the first direction is a height direction of the first body, a second direction is substantially orthogonal to the first direction, and a third direction is substantially orthogonal to the first direction and crosses the second direction,
the at least one first terminal includes
a first retainable portion retained in the first body,
a first contacting portion extending from the first retainable portion to one side in the first direction, the first contacting portion being exposed, or protruding, at least partly from the first body, and
a first mountable portion,
the second connector part includes
a second body being constituted by an insulating material, extending in the first direction, and being disposed in spaced relation to, and on the other side in the second direction relative to, the first body, and
at least one second terminal constituted by an electrically conductive material,
the at least one second terminal includes
a second retainable portion retained in the second body,
a second contacting portion extending from the second retainable portion to the one side in the first direction, the second contacting portion being exposed, or protruding, at least partly from the second body, and
a second mountable portion at least partly located on the other side in the first direction, the other side in the second direction, one side in the third direction, or the other side in the third direction relative to the second body, and
the coupling part couples the first body and the second body and includes at least one through hole extending through the coupling part in the first direction, and a part of the first mountable portion of the at least one first terminal is disposed on the other side in the first direction relative to, or disposed in, the at least one through hole.

8. The hybrid connector according to claim 7, wherein
the first mountable portion of the at least one first terminal extends at least partly to the other side in the second direction, the one side in the third direction, or the other side in the third direction,
the second mountable portion of the at least one second terminal extends at least partly to the other side in the second direction and is located at least partly on the other side in the second direction relative to the second body, extends at least partly to the one side in the third direction and is located at least partly on the one side in the third direction relative to the second body, or extends at least partly to the other side in the third direction and is located at least partly on the other side in the third direction relative to the second body,
a face on the other side in the first direction of the first mountable portion of the at least one first terminal and a face on the other side in the first direction of the second mountable portion of the at least one second terminal are located at substantially the same height positions in the first direction.

9. The hybrid connector according to claim 8, wherein
a face on the other side in the first direction of the coupling part is located on the one side in the first direction relative to a face on the other side in the first direction of the first body on the other side in the first direction, and
the part of the first mountable portion of the at least one first terminal is disposed on the other side in the first direction relative to the at least one through hole.

10. The hybrid connector according to claim 7, wherein
the part of the first mountable portion of the at least one first terminal extends to the other side in the first direction to be located on the other side in the first direction relative to the at least one through hole of the coupling part, and
the second mountable portion of the at least one second terminal at least partly extends to the other side in the first direction and is at least partly located on the other side in the first direction relative to the second body.

11. A hybrid connector comprising:
a first connector part;
a second connector part; and
a coupling part, wherein
the first connector part includes
a first body being constituted by an insulating material and extending in a first direction, and
at least one first terminal constituted by an electrically conductive material,
the at least one first terminal includes
a first retainable portion retained in the first body,
a first contacting portion extending from the first retainable portion to one side in the first direction, the first contacting portion being exposed, or protruding, at least partly from the first body, and
a first mountable portion at least partly located on the other side in the first direction, one side in a second direction, one side in a third direction, or the other side in the third direction relative to the first body, wherein the first direction is a height direction of the first body, the second direction is substantially orthogonal to the first direction, and the third direction is substantially orthogonal to the first direction and crosses the second direction,
the second connector part includes
a second body being constituted by an insulating material, extending in the first direction, and being disposed in spaced relation to, and on the other side in the second direction relative to, the first body, and
at least one second terminal constituted by an electrically conductive material,
the at least one second terminal includes
a second retainable portion retained in the second body,
a second contacting portion extending from the second retainable portion to the one side in the first direction, the second contacting portion being exposed, or protruding, at least partly from the second body, and
a second mountable portion, and
the coupling part couples the first body and the second body and includes at least one through hole extending through the coupling part in the first direction, and a part of the second mountable portion of the at least one second terminal is disposed on the other side in the first direction relative to, or disposed in, the at least one through hole.

12. The hybrid connector according to claim 11, wherein
the first mountable portion of the at least one first terminal extends at least partly to the one side in the second direction and is located at least partly on the one side in the second direction relative to the first body, extends at least partly to the one side in the third direction and is located at least partly on the one side in the third direction relative to the first body, or extends at least partly on the other side in the third direction and is located at least partly on the other side in the third direction relative to the first body,
the second mountable portion of the at least one second terminal extends to the one side in the second direction, the one side in the third direction, or the other side in the third direction, and,
a face on the other side in the first direction of the first mountable portion of the at least one first terminal and a face on the other side in the first direction of the second mountable portion of the at least one second terminal are located at substantially the same height position in the first direction.

13. The hybrid connector according to claim 12, wherein
a face on the other side in the first direction of the coupling part is located on the one side in the first direction relative to a face on the other side in the first direction of the first body, and
the part of the second mountable portion of the at least one second terminal is disposed on the other side in the first direction relative to the at least one through hole.

14. The hybrid connector according to claim 11, wherein
the first mountable portion of the at least one first terminal at least partly extends to the other side in the first direction and is at least partly located on the other side in the first direction relative to the first body, and
the part of the second mountable portion of the at least one second terminal extends to the other side in the first direction to be located on the other side in the first direction relative to the at least one through hole of the coupling part.

15. The hybrid connector according to claim 7, wherein
the first connector part further includes a shell having electrical conductivity,
the shell includes a shell body covering at least a part of an outer face of the first body, and at least one third mountable portion, and
the at least one third mountable portion of the shell is at least partly disposed on the other side in the first direction relative to, or at least partly disposed in, the at least one through hole of the coupling part.

16. The hybrid connector according to claim 11, wherein
the first connector part further includes a shell having electrical conductivity,
the shell includes a shell body covering at least a part of an outer face of the first body, and at least one third mountable portion, and
the at least one third mountable portion of the shell is at least partly disposed on the other side in the first direction relative to, or at least partly disposed in, the at least one through hole of the coupling part.

17. The hybrid connector according to claim 7, wherein
the first connector part further includes a shell having electrical conductivity,
the shell has a shell body, and
the shell body is shaped like a tube extending in the first direction, fits over the first body from the one side in the first direction, and abuts a boundary portion between the first body and the coupling part from the one side in the first direction.

18. The hybrid connector according to claim 11, wherein
the first connector part further includes a shell having electrical conductivity,
the shell has a shell body, and
the shell body is shaped like a tube extending in the first direction, fits over the first body from the one side in the first direction, and abuts a boundary portion between the first body and the coupling part from the one side in the first direction.

19. The hybrid connector according to claim 7, wherein
the first connector part further includes a shell having electrical conductivity,
the shell has a shell body, and
the shell body of the shell is shaped like a tube extending in the first direction and covers at least a part of an outer peripheral face of the first body, and
the at least one first terminal is a single first terminal, and the first retainable portion and/or the first contacting portion is arranged substantially coaxially with the first body and the shell body.

20. The hybrid connector according to claim 11, wherein
the first connector part further includes a shell having electrical conductivity,
the shell has a shell body, and
the shell body of the shell is shaped like a tube extending in the first direction and covers at least a part of an outer peripheral face of the first body, and
the at least one first terminal is a single first terminal, and the first retainable portion and/or the first contacting portion is arranged substantially coaxially with the first body and the shell body.
